(19) United States
(12) Patent Application Publication
(10) Pub. No.: US 2026/0079057 A1
(43) Pub. Date: Mar. 19, 2026

(54) LINEAR ACTUATOR WITH FORCE DETECTING MECHANISM

(71) Applicant: TIMOTION TECHNOLOGY CO., LTD., New Taipei City (TW)

(72) Inventor: Yu-Chang LIN, New Taipei City (TW)

(21) Appl. No.: 19/270,074

(22) Filed: Jul. 15, 2025

Related U.S. Application Data
(60) Provisional application No. 63/694,365, filed on Sep. 13, 2024.

(51) Int. Cl. G01L 5/00; G01L 1/12

(52) U.S. Cl. CPC G01L 5/0038; G01L 1/122

(57) ABSTRACT

A linear actuator with a force detecting mechanism includes: a housing body (10) having a fasten component (11); a transmission mechanism (20) connected to the housing body (10) and having a forced component (21); an elastic body (30) disposed between the fasten component (11) and the forced component (21); and a Hall sensing set (40) disposed between the fasten component (11) and the forced component (21); when a force applied to the transmission mechanism (20) is changed, a relative displacement is generated between the forced component (21) and the fasten component (11), and thus an output signal is generated by the Hall sensing set (40) due to the displacement. Accordingly, advantages of preventing the equipment from being damaged due to impacts and realizing whether a patient is in a lying in bed or an absenting status at any desired time are provided.

### CROSS-REFERENCE TO RELATED APPLICATION

This patent application claims the benefit of United States Provisional Ser. No. 63/694,365 , filed Sep. 13, 2024, which is incorporated by reference herein.

### BACKGROUND OF THE DISCLOSURE

### Technical Field

The present disclosure relates to a linear actuator, especially to a linear actuator with a force detecting mechanism.

### Description of Related Art

A related-art linear actuator is commonly applied in an electric bed, a nursing bed, a ward bed, an electric lifting desk or chair and used to adjust the height or the elevation angle. When the aforesaid equipment encounters an obstacle during a process of adjusting the equipment, an interaction force is generated when the equipment is in contact with the obstacle, and the aforesaid action force is transferred to the linear actuator. The linear actuator may be damaged due to the obstacle if the operation of the linear actuator is not immediately stopped. Moreover, a human may be hurt when the obstacle is the human himself.

Moreover, the related-art linear actuator is not provided with a dynamic detecting function. When being applied in a medical bed frame, the medical personnel or the relatives of the patient may not actually realize whether the patient is in a lying in bed or an absenting status via a terminal device or equipment.

As such, how to prevent the equipment from being damaged and prevent the patient from being hurt due to collisions and how to realize whether the patient is in the lying in bed or the absenting status shall be improved.

Accordingly, the applicant of the present disclosure has devoted himself for improving the mentioned shortages.

### SUMMARY OF THE DISCLOSURE

The present disclosure provides a linear actuator with a force detecting mechanism, which has advantages of preventing the equipment from being damaged due to collisions and realizing whether a patient is in a lying in bed or an absenting status at any desired time.

Accordingly, the present disclosure provides a linear actuator with a force detecting mechanism, which includes a housing body, a transmission mechanism, an elastic body and a Hall sensing set. The housing body includes a fasten component. The transmission mechanism is connected to the housing body and includes a forced component. The elastic body is disposed between the fasten component and the forced component. The Hall sensing set is disposed between the fasten component and the forced component. Moreover, when a force applied to the transmission mechanism is changed, a relative displacement is generated between the forced component and the fasten component, and an output signal is generated by the Hall sensing set due to the displacement.

In comparison with related art, the present disclosure has advantageous features as follows. During a process of a retractable pipe being protruded or retracted, the elastic body disposed inside generates a slight deformation when a provided load is changed, a gap defined between a first sensing member and a second sensing member is changed to make the output signal be generated, the output signal is transmitted to a control box or a control terminal, and thus the medical personnel may determine whether the patient is in the lying in bed or the absenting status (defined as a dynamic detecting function provided to the bed frame). Moreover, a collision warning function is also provided, when encountering an obstacle during the process of the retractable pipe being protruded or retracted, the retractable pipe may not be smoothly protruded or retracted or a force applied to a lead screw is changed due to the retractable pipe being impacted, the elastic body generates deformations, and a deforming level of the elastic body is sensed by the Hall sensing set and a sensed result is sent to the control box, and thus the power supply to an electric push rod is terminated to increase the operation safety. Accordingly, the linear actuator with the force detecting mechanism of the present disclosure has a simple and compact structure and is easy to be assembled, and the material cost is low.

### BRIEF DESCRIPTION OF THE DRAWINGS

FIG. 1 is an exploded view according to the first embodiment of the present disclosure;

FIG. 2 is a schematic view showing the assembly of the partial components according to the first embodiment of the present disclosure;

FIG. 3 is an exploded view showing the partial components according to the first embodiment of the present disclosure;

FIG. 4 is a cross-sectional view showing the assembly of the partial components according to the first embodiment of the present disclosure;

FIG. 5 is a partially enlarged view of FIG. 4 according to the first embodiment of the present disclosure;

FIG. 6 is a cross-sectional view showing an operating status according to the first embodiment of the present disclosure;

FIG. 7 is a cross-sectional view showing the assembly according to the second embodiment of the present disclosure;

FIG. 8 is an exploded view according to the third embodiment of the present disclosure;

FIG. 9 is a cross-sectional view showing the assembly according to the third embodiment of the present disclosure;

FIG. 10 is a cross-sectional view showing the assembly according to the fourth embodiment of the present disclosure;

FIG. 11 is an exploded view according to the fifth embodiment of the present disclosure;

FIG. 12 is a cross-sectional view showing the assembly according to the fifth embodiment of the present disclosure;

FIG. 13 is a cross-sectional view showing the assembly according to the sixth embodiment of the present disclosure;

FIG. 14 is a schematic view showing the assembly according to the seventh embodiment of the present disclosure;

FIG. 15 is a cross-sectional view showing the assembly according to the seventh embodiment of the present disclosure;

FIG. 16 is an exploded view according to the eighth embodiment of the present disclosure;

FIG. 17 is an enlarged view showing the assembly of the partial components according to the eighth embodiment of the present disclosure;

FIG. 18 is an exploded view showing the partial components according to the eighth embodiment of the present disclosure;

FIG. 19 is a cross-sectional view showing the assembly according to the eighth embodiment of the present disclosure;

FIG. 20 is an exploded view according to the ninth embodiment of the present disclosure;

FIG. 21 is a schematic view showing the assembly of the partial components according to the ninth embodiment of the present disclosure;

FIG. 22 is a cross-sectional view showing the assembly according to the ninth embodiment of the present disclosure;

FIG. 23 is a cross-sectional view showing the assembly according to the tenth embodiment of the present disclosure;

FIG. 24 is an exploded view according to the eleventh embodiment of the present disclosure;

FIG. 25 is a cross-sectional view showing the assembly according to the eleventh embodiment of the present disclosure;

FIG. 26 is a cross-sectional view showing the assembly according to the twelfth embodiment of the present disclosure;

FIG. 27 is a cross-sectional view showing the assembly according to the thirteenth embodiment of the present disclosure;

FIG. 28 is an exploded view according to the fourteenth embodiment of the present disclosure;

FIG. 29 is a cross-sectional view showing the assembly according to the fourteenth embodiment of the present disclosure;

FIG. 30 is a cross-sectional view showing the assembly according to the fifteenth embodiment of the present disclosure;

FIG. 31 is an exploded view according to the sixteenth embodiment of the present disclosure;

FIG. 32 is a cross-sectional view showing the assembly according to the sixteenth embodiment of the present disclosure;

FIG. 33 is a cross-sectional view showing the assembly according to the seventeenth embodiment of the present disclosure;

FIG. 34 is an exploded view according to the eighteenth embodiment of the present disclosure;

FIG. 35 is a cross-sectional view showing the assembly according to the eighteenth embodiment of the present disclosure;

FIG. 36 is a cross-sectional view showing the assembly according to the nineteenth embodiment of the present disclosure;

FIG. 37 is an exploded view according to the twentieth embodiment of the present disclosure;

FIG. 38 is a cross-sectional view showing the assembly according to the twentieth embodiment of the present disclosure; and

FIG. 39 is a cross-sectional view showing the assembly according to the twenty-first embodiment of the present disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

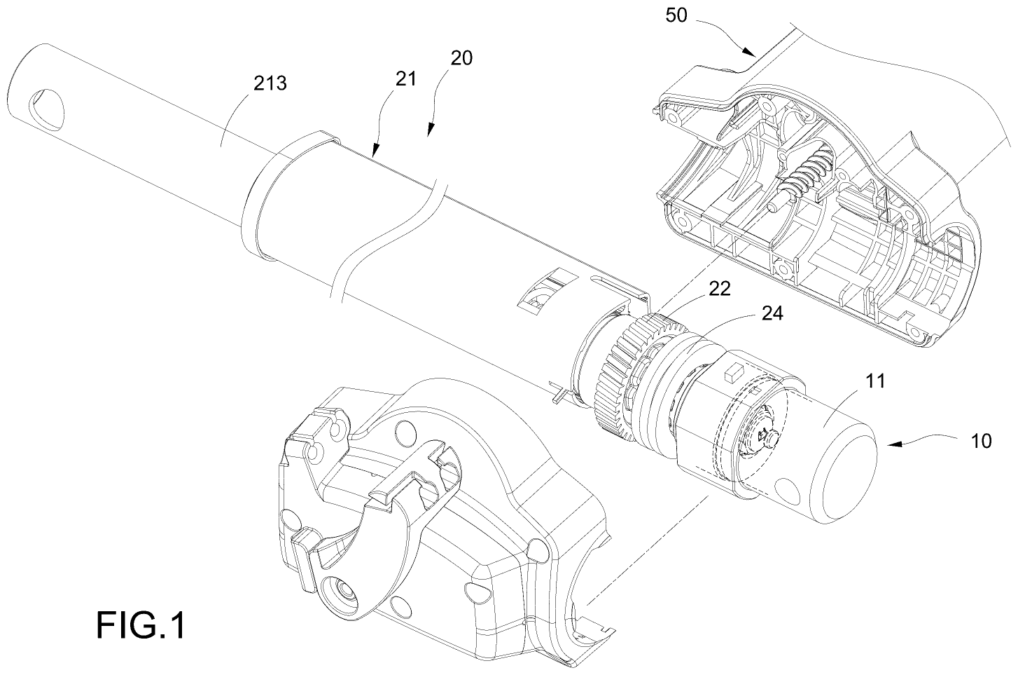

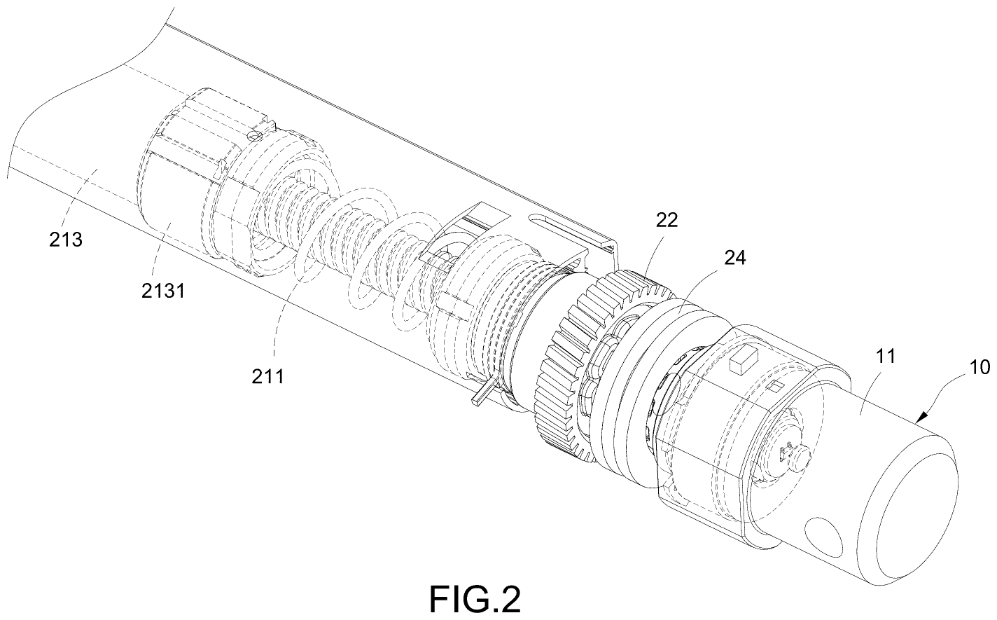

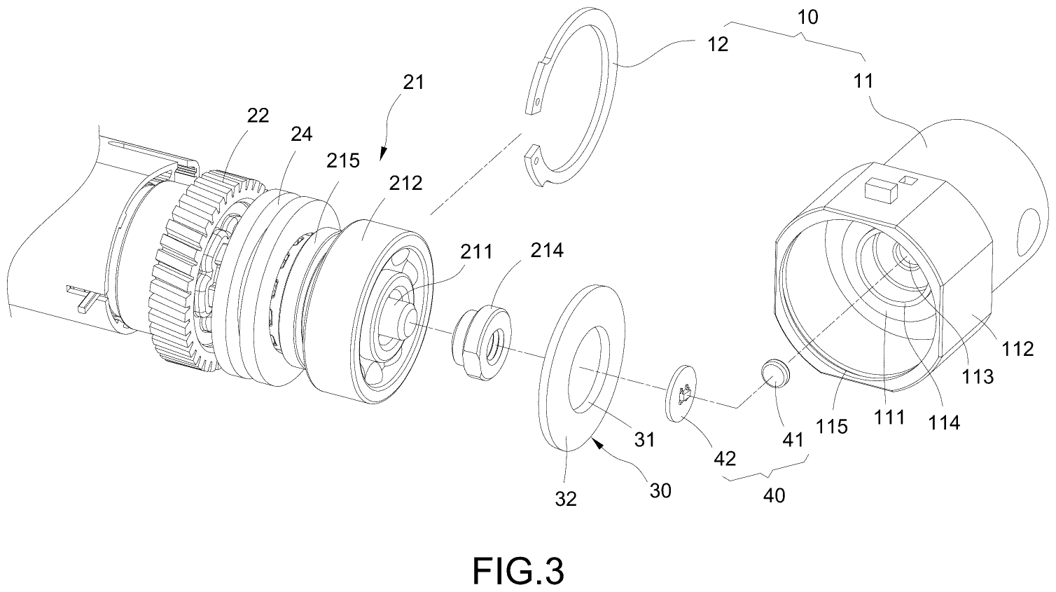

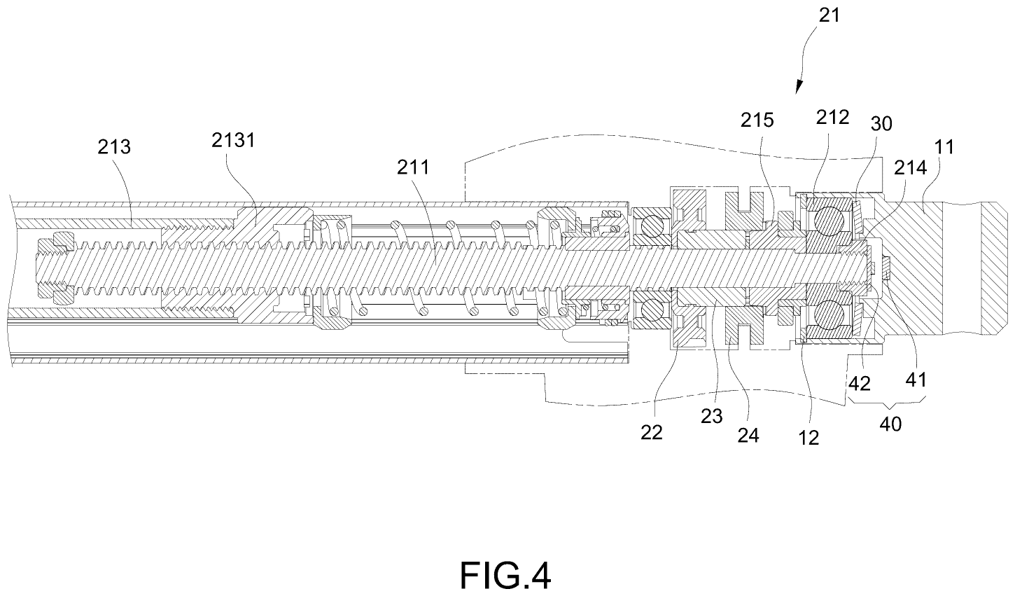

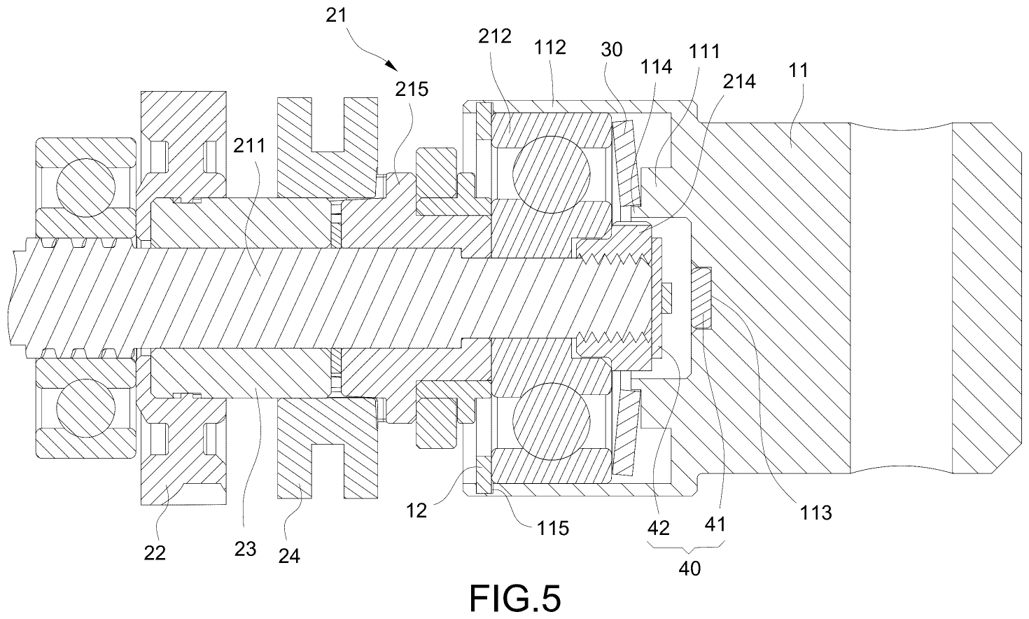

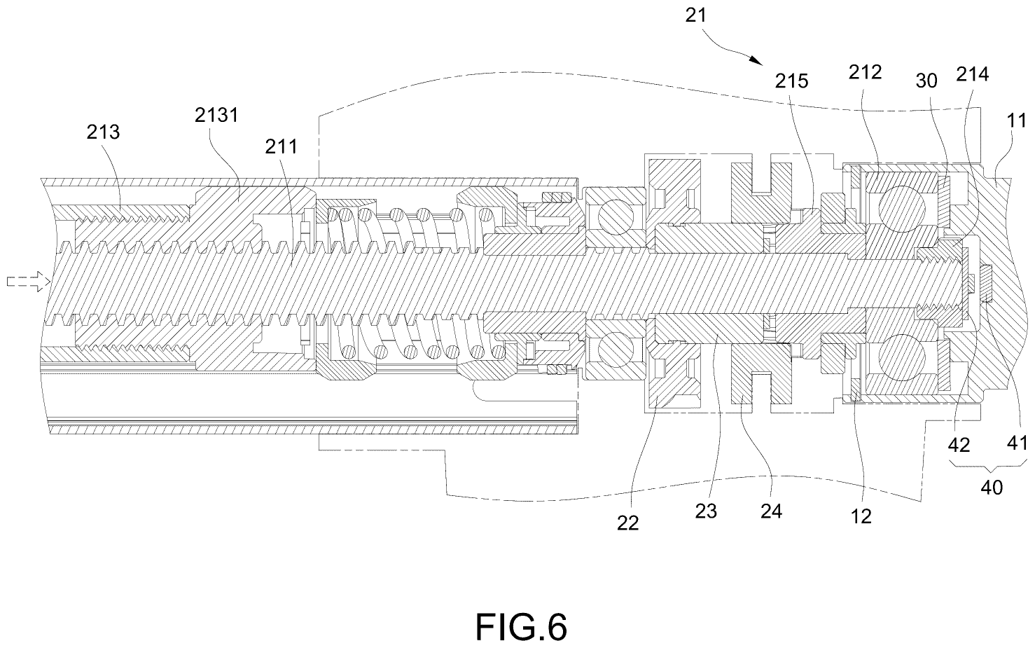

The present disclosure provides a linear actuator with a force detecting mechanism. Please refer from FIG. 1 to FIG. 6, which are an exploded view, a schematic view showing the assembly of the partial components, an exploded showing the partial components, a cross-sectional view showing the assembly of the partial components, a partially enlarged view of FIG. 4 and a cross-sectional view showing an operating status according to the first embodiment of the present disclosure.

According to this embodiment, the linear actuator is an electric push rod, which mainly includes a housing body 10, a transmission mechanism 20, an elastic body 30 and a Hall sensing set 40.

The housing body 10 mainly includes a fasten component 11 and a buckling ring 12. According to this embodiment, the fasten component 11 is a rear supporter of the electric push rod. The fasten component 11 includes a convex piece 111 and an outer annular member 112 disposed at an outer circumference of the convex piece 111. A cavity 113 is disposed at a central location of the convex piece 111. An inner annular ring 114 is disposed on an end surface of the convex piece 111, and a mounting slot 115 is disposed on an inner wall of the outer annular member 112.

The transmission mechanism 20 is connected to the housing body 10. According to this embodiment, the transmission mechanism 20 mainly includes a forced component 21. The forced component 21 mainly includes a machine core 211, a bearing 212, a retractable pipe 213, a locking member 214 and a fixed gear 215. One end of the machine core 211 passes through the bearing 212. One end of the retractable pipe 213 is connected to a screw nut 2131, and the retractable pipe 213 is screwed with machine core 211 via the screw nut 2131 for transmissions. The locking member 214 is locked with the machine core 211 and tightly press the bearing 212. The bearing 212 is accommodated in the outer annular member 112, and the bearing 212 is stopped through the buckling ring 12 being mounted in the mounting slot 115. The fixed gear 215 sheaths the machine core 211 and abuts against an end surface of the bearing 212.

According to this embodiment, the transmission mechanism 20 further includes a worm gear 22, a guiding member 23 and a clutch gear 24. The guiding member 23sheaths the machine core 211. The worm gear 22sheaths the guiding member 23. The clutch gear 24 sheaths the guiding member 23 and the fixed gear 215, and thus the clutch gear 24 axially moves along the guiding member 23 to perform engaging or releasing actions with the fixed gear 215.

According to this embodiment, the elastic body 30 is an inclined disc-shaped elastic sheet. The elastic body 30 is disposed between the fasten component 11 and the forced component 21. The elastic body 30 has a central hole 31 and an inclined plate 32 disposed at an outer circumference of the central hole 31. The central hole 31 sheaths the inner annular ring 114. The inclined plate 32 abuts against the end surface of the bearing 212 in a zone away from the central hole 31.

The Hall sensing set 40 mainly includes a first sensing member 41 and a second sensing member 42 disposed relative to the first sensing member 41. The first sensing member 41 is disposed in the cavity 113 of the fasten component 11. The second sensing member 42 is disposed on an end surface of the machine core 211 of the forced component 21. The first sensing member 41 may be a Hall sensor or a magnetic member, and the second sensing member 42 may be a Hall sensor or a magnetic member. According to this embodiment, the first sensing member 41 is a magnetic member, and the second sensing member 42 is a Hall sensor. The magnetic member may be a magnet or a magnetizing member.

According to this embodiment, the linear actuator further includes a drive mechanism 50. The drive mechanism 50 is connected to the transmission mechanism 20 and the housing body 10. The drive mechanism 50 drives the worm gear 22 and the machine core 211 of the transmission mechanism 20 to generate corresponding actions. The drive mechanism 50 is well known by skilled people, therefore no further illustration is provided.

When being operated, the retractable pipe 213 of the transmission mechanism 20 is applied with an axial force, and the elastic body 30 generates deformations, a gap defined between the forced component 21 and the fasten component 11 is changed, and a gap defined between the first sensing member 41 and the second sensing member 42 is also changed, and thus a signal is outputted with a telecommunicating manner. The axial force may be a pull force or a push force applied to the retractable pipe 213.

Details are provided as follows. When the electric push rod is subjected to an external load, the load is transmitted from the retractable pipe 213 to the screw nut 2131, the load is transmitted to the machine core 211 through the machine core 211 being screwed with the screw nut 2131, then the load is transmitted from the machine core 211 to the fixed gear 215 through the fixed gear 215 being mechanically connected to the machine core 211; thus the load is transmitted to the bearing 212, and the load is transmitted from the bearing 212 to the elastic body 30. Because the second sensing member 42 is fastened on the end surface of the machine core 211 and the locking member 214, and the first sensing member 41 is disposed in the cavity 113 of the fasten component 11, the elastic body 30 generates deformations due to a loading action, and a gap defined between the machine core 211 of the forced component 21 and the convex piece 111 of the fasten component 11 is changed, meanwhile a gap defined between the second sensing member 42 and the first sensing member 41 is changed. The greater the gap defined between the second sensing member 42 and the first sensing member 41, the weaker a received Gaussian value. On the other hand, the smaller the gap defined between the second sensing member 42 and the first sensing member 41, the stronger the received Gaussian value. A displacement signal is outputted to a controller or a control terminal to terminate the power supply or force a motor to generate rotations in an opposite direction, and thus the electric push rod has a protecting effect.

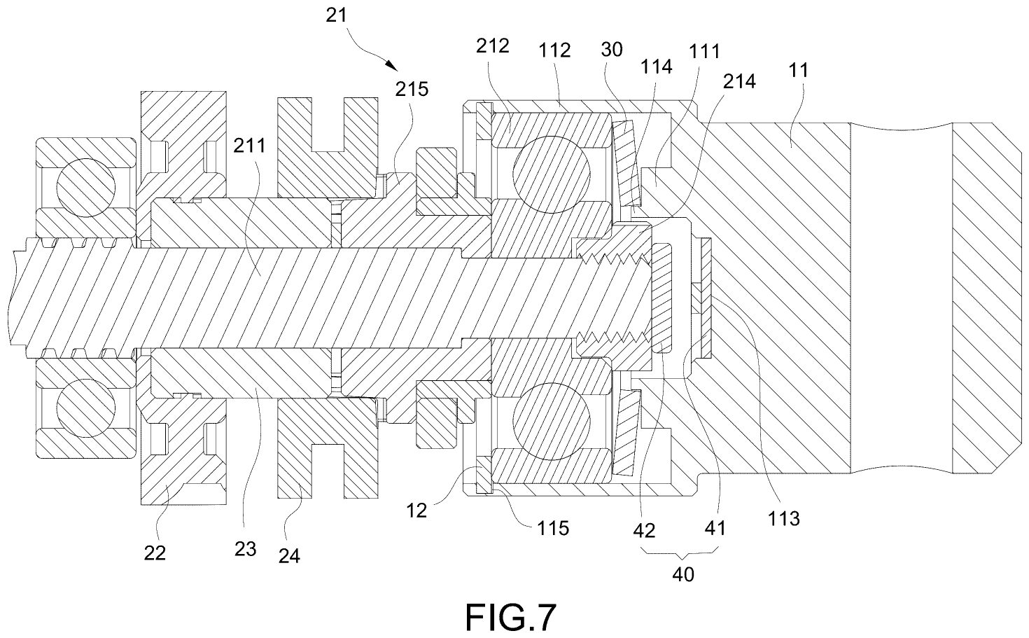

Please refer to FIG. 7, which is a cross-sectional view showing the assembly according to the second embodiment of the present disclosure. According to this embodiment, the linear actuator is an electric push rod. The structure of the linear actuator disclosed in this embodiment is substantially the same as the structure disclosed in the first embodiment. The differences between this embodiment and the first embodiment are provided as follows. According to this embodiment, the first sensing member 41 is a Hall sensor, and the second sensing member 42 is a magnetic member.

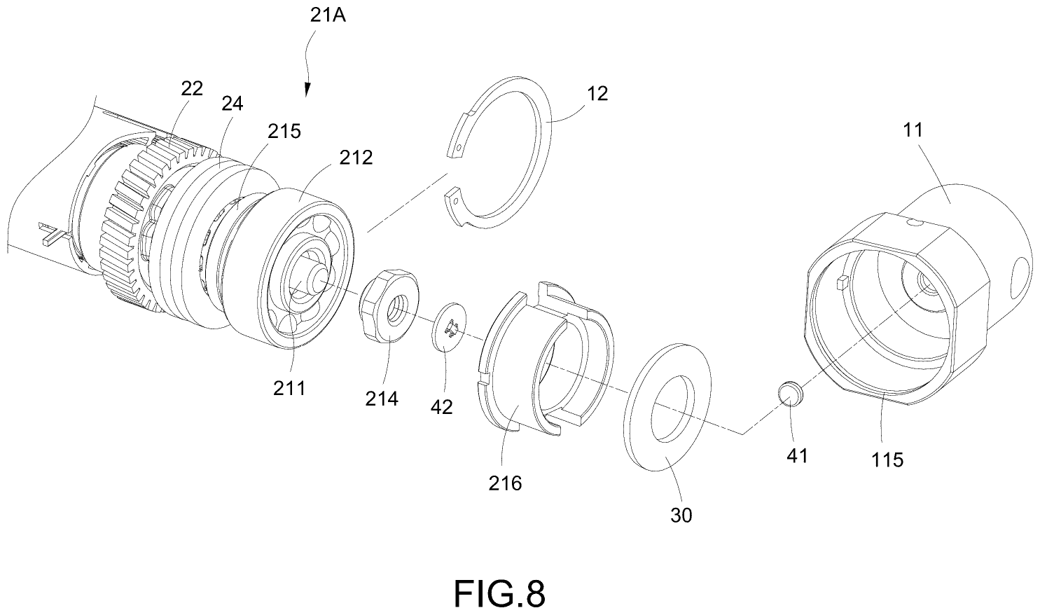

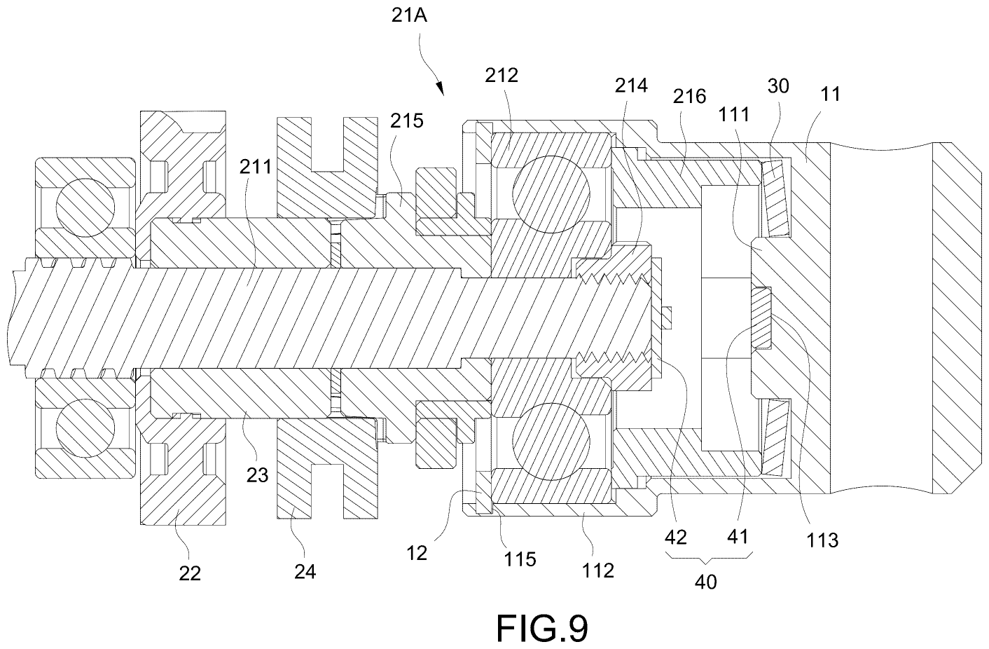

Please refer to FIG. 8 and FIG. 9, which are an exploded view and a cross-sectional view showing the assembly according to the third embodiment of the present disclosure. According to this embodiment, the linear actuator is an electric push rod. The structure of the linear actuator disclosed in this embodiment is substantially the same as the structure disclosed in the first embodiment. The differences between this embodiment and the first embodiment are provided as follows. According to this embodiment, the forced component 21A further includes a sleeve 216. The sleeve 216 is disposed between the bearing 212 and the elastic body 30. The elastic body 30 is disposed at an outer circumference of the convex piece 111. The first sensing member 41 is disposed in the cavity 113. When the retractable pipe 213 of the transmission mechanism 20 is applied with an axial force, the sleeve 216 is pushed by the bearing 212, the sleeve 216 makes the elastic body 30 generate deformations, thus a gap defined between the machine core 211 of the forced component 21A and the convex piece 111 of the fasten component 11 is changed, and a signal is generated between the first sensing member 41 and the second sensing member 42 to be outputted. According to this embodiment, the first sensing member 41 is a magnetic member, and the second sensing member 42 is a Hall sensor.

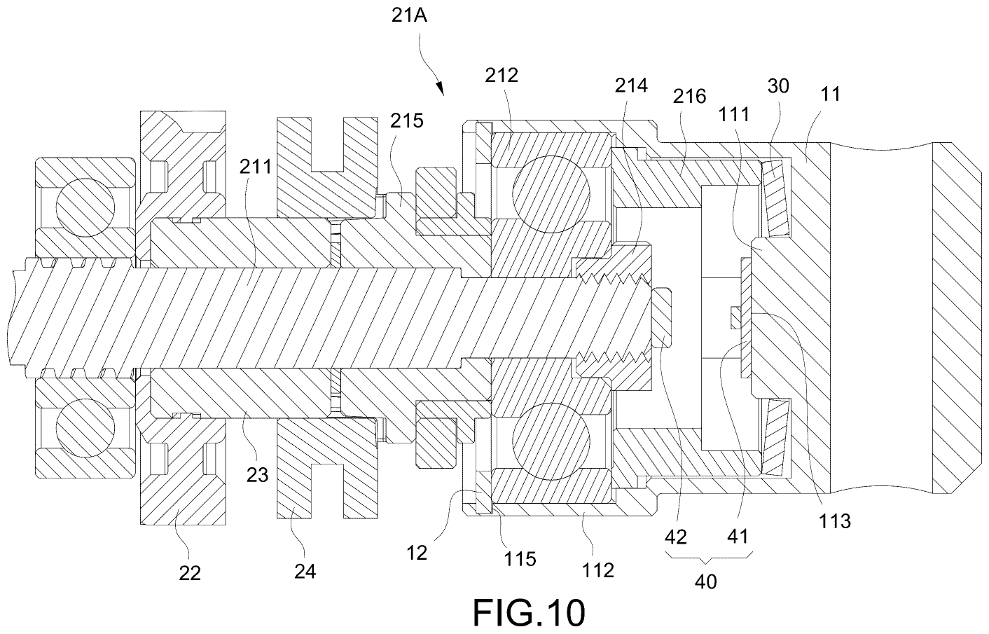

Please refer to FIG. 10, which is a cross-sectional view showing the assembly according to the fourth embodiment of the present disclosure. According to this embodiment, the linear actuator is an electric push rod. The structure of the linear actuator disclosed in this embodiment is substantially the same as the structure disclosed in the third embodiment. The differences between this embodiment and the third embodiment are provided as follows. According to this embodiment, the first sensing member 41 is a Hall sensor, and the second sensing member 42 is a magnetic member. The first sensing member 41 is disposed on an end surface of the convex piece 111.

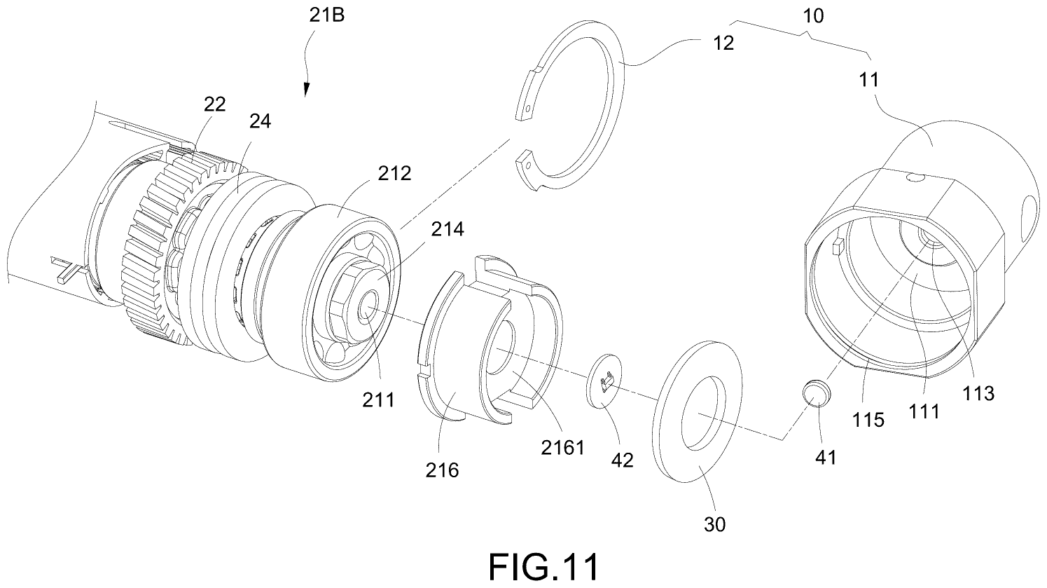

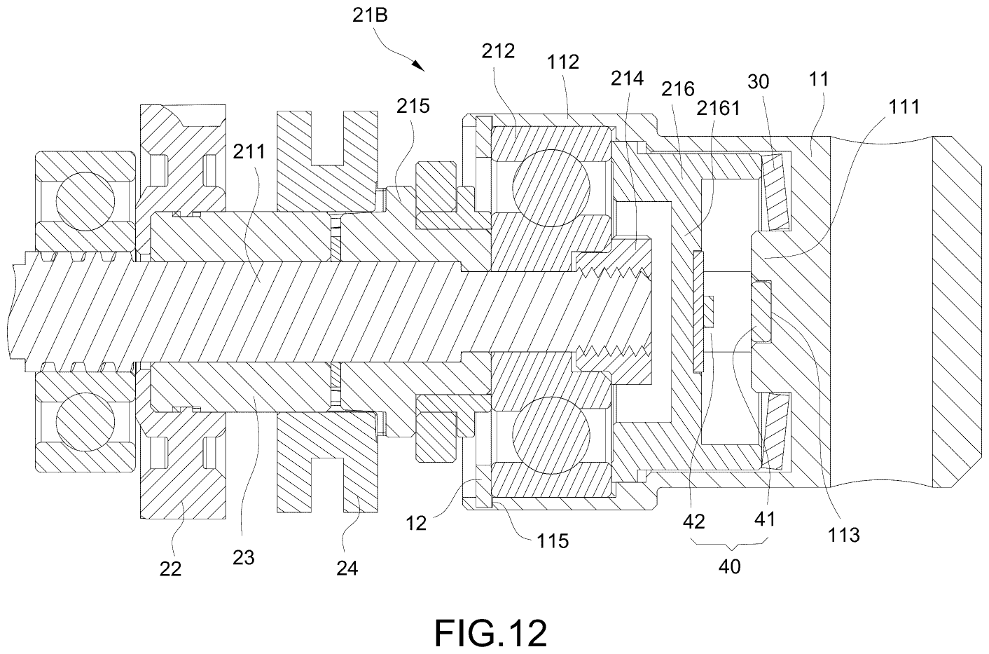

Please refer to FIG. 11 and FIG. 12, which are an exploded view and a cross-sectional view showing the assembly according to the fifth embodiment of the present disclosure. According to this embodiment, the linear actuator is an electric push rod. The structure of the linear actuator disclosed in this embodiment is substantially the same as the structure disclosed in the third embodiment. The differences between this embodiment and the third embodiment are provided as follows. According to this embodiment, the forced component 21B further includes a sleeve 216. The sleeve 216 includes a middle partition plate 2161. The second sensing member 42 is disposed on the middle partition plate 2161. The elastic body 30 sheaths the outer circumference of the convex piece 111. The first sensing member 41 is disposed in the cavity 113. When the retractable pipe 213 of the transmission mechanism 20 is applied with an axial force, the sleeve 216 is pushed by the bearing 212, the sleeve 216 makes the elastic body 30 generate deformations, thus a gap defined between the middle partition plate 2161 of the forced component 21B and the convex piece 111 of the fasten component 11 is changed, and a signal is generated between the first sensing member 41 and the second sensing member 42 to be outputted. According to this embodiment, the first sensing member 41 is a magnetic member, and the second sensing member 42 is a Hall sensor.

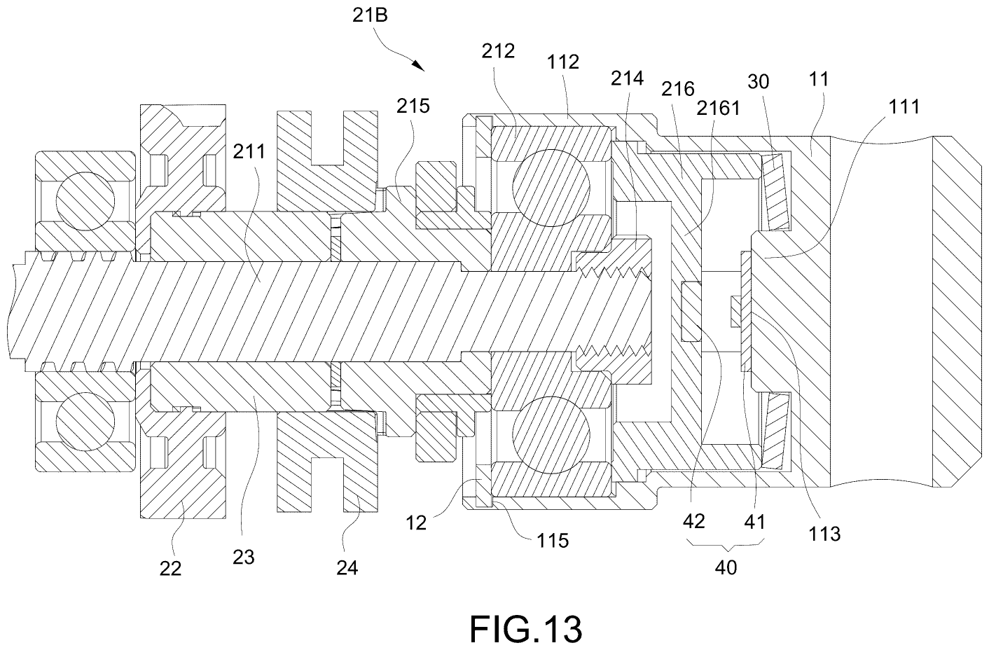

Please refer to FIG. 13, which is a cross-sectional view showing the assembly according to the sixth embodiment of the present disclosure. According to this embodiment, the linear actuator is an electric push rod. The structure of the linear actuator disclosed in this embodiment is substantially the same as the structure disclosed in the fifth embodiment. The differences between this embodiment and the fifth embodiment are provided as follows. According to this embodiment, the first sensing member 41 is disposed on an end surface of the convex piece 111. The first sensing member 41 is a Hall sensor, and the second sensing member 42 is a magnetic member.

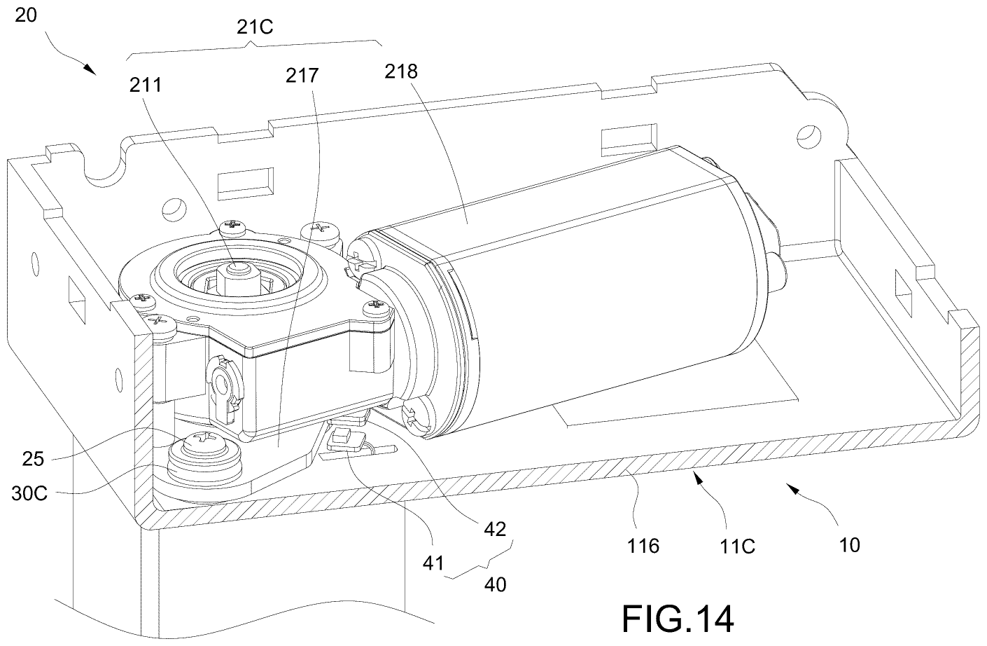

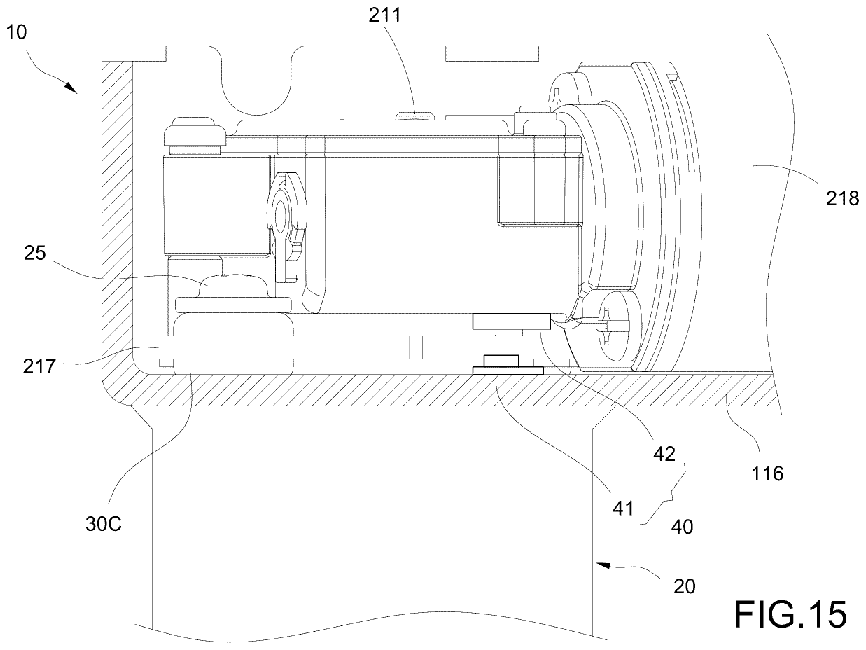

Please refer to FIG. 14 and FIG. 15, which are a schematic view and a cross-sectional view showing the assembly according to the seventh embodiment of the present disclosure. According to this embodiment, the linear actuator is a lifting column. The fasten component 11C is a motor case of the lifting column. The fasten component 11C includes a bottom plate 116. The first sensing member 41 is disposed on the bottom plate 116, and the first sensing member 41 is a Hall sensor.

The transmission mechanism 20 is connected to the housing body 10. According to this embodiment, the transmission mechanism 20 mainly includes a forced component 21C. The forced component 21C mainly includes a machine core 211, a fasten plate 217 and a motor 218. In this embodiment, an elastic body 30C is a rubber sleeve. The fasten plate 217 is fastened on the bottom plate 116 through a screw bolt 25 and the elastic body 30C. The machine core 211 passes through the motor 218. The motor 218 is locked and fastened on the fasten plate 217. The second sensing member 42 is disposed on the motor 218 and arranged corresponding to the first sensing member 41. The second sensing member 42 is a magnetic member.

When being operated, the machine core 211 is applied with an axial force, and the elastic body 30C generates deformations, a gap defined between the motor 218 and the bottom plate 116 is changed, and thus a signal is generated between the first sensing member 41 and the second sensing member 42 to be outputted.

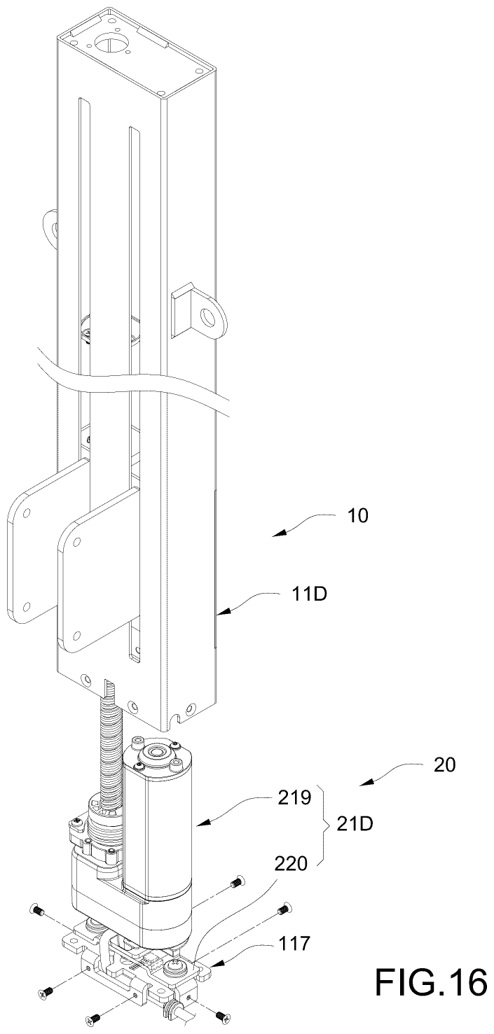

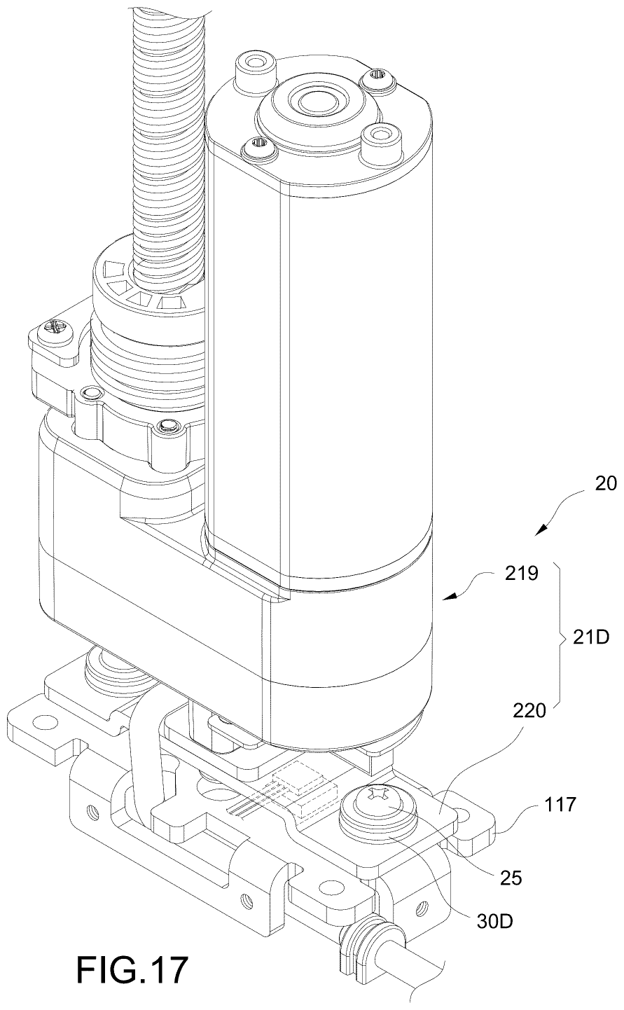

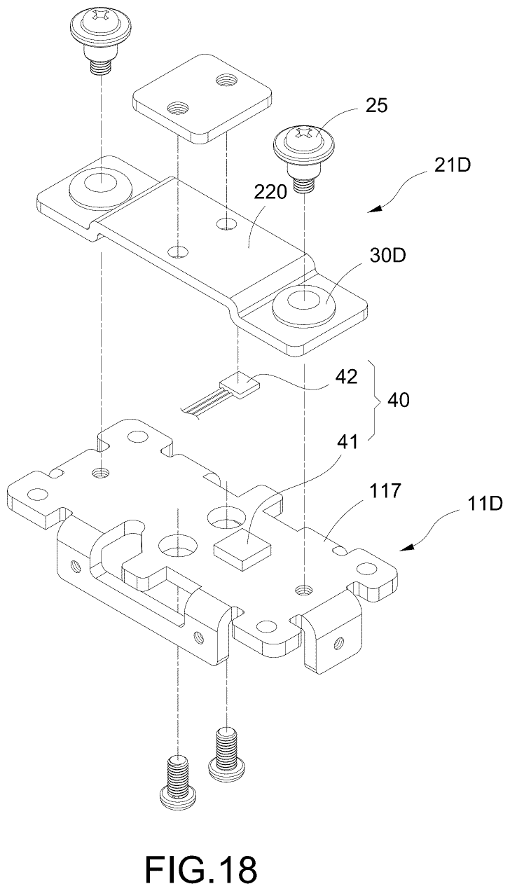

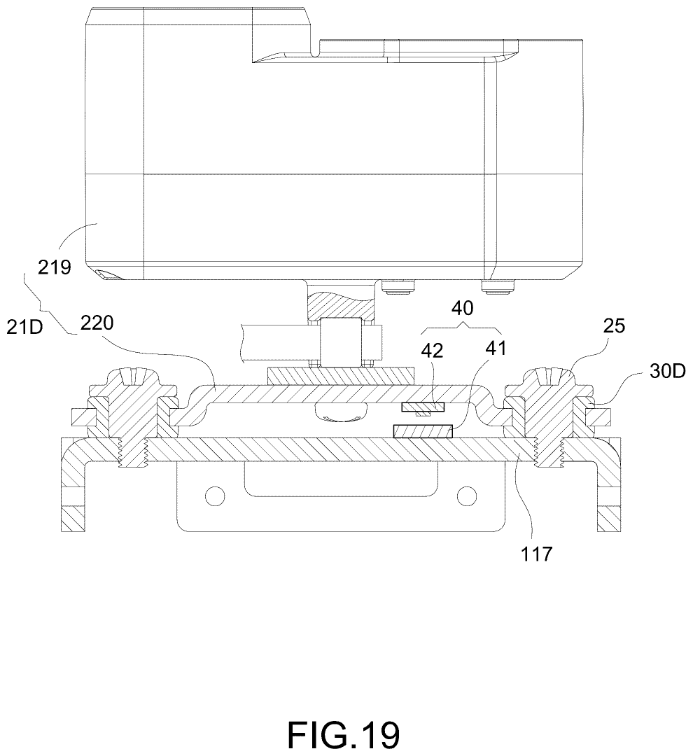

Please refer to FIG. 16 to FIG. 19, which are an exploded view, an enlarged view showing the assembly of the partial components, an exploded view showing the partial components and a cross-sectional view showing the assembly according to the eighth embodiment of the present disclosure. According to this embodiment, the linear actuator is a lifting column. The fasten component 11D is a pipe member of the lifting column. The fasten component 11D includes a bottom cover 117. The first sensing member 41 is disposed on the bottom cover 117, and the first sensing member 41 is a magnetic member.

The transmission mechanism 20 is connected to the housing body 10. According to this embodiment, the transmission mechanism 20 mainly includes a forced component 21D. The forced component 21D mainly includes an electric push rod 219 and an installing plate 220. In this embodiment, an elastic body 30D is a rubber sleeve, the installing plate 220 is fastened on the bottom cover 117 through the screw bolt 25 and the elastic body 30D. One end of the electric push rod 219 is fastened on the installing plate 220. The second sensing member 42 is disposed on the installing plate 220 and arranged corresponding to the first sensing member 41. The second sensing member 4 is a Hall sensor.

When being operated, a machine core of the electric push rod 219 is applied with an axial force, and the elastic body 30D generates deformations, a gap defined between the installing plate 220 and the bottom cover 117 is changed, and thus a signal is generated between the first sensing member 41 and the second sensing member 42 to be outputted.

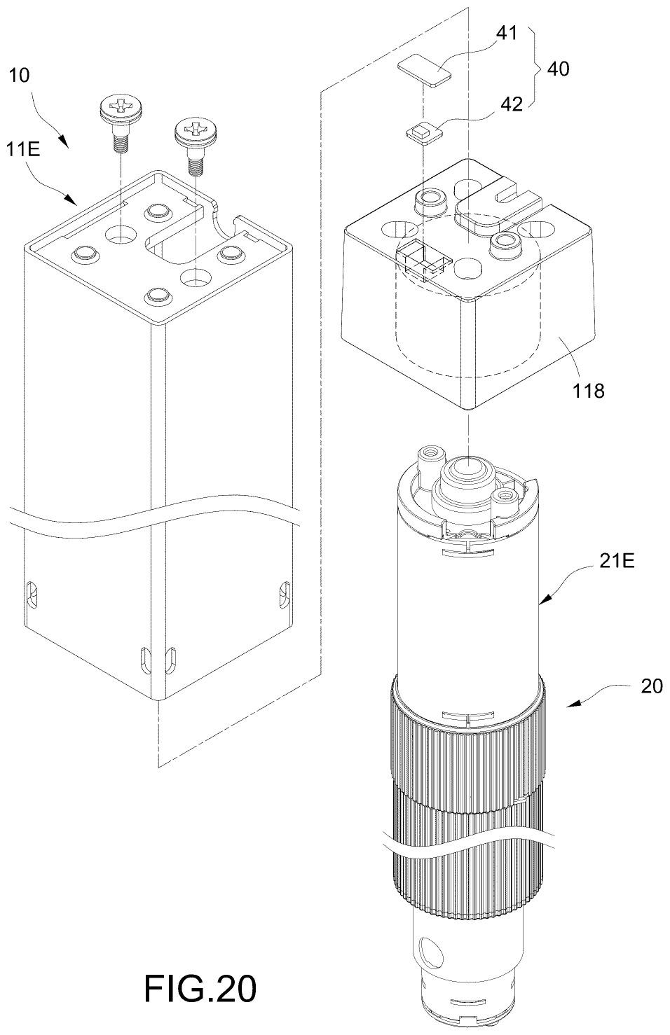

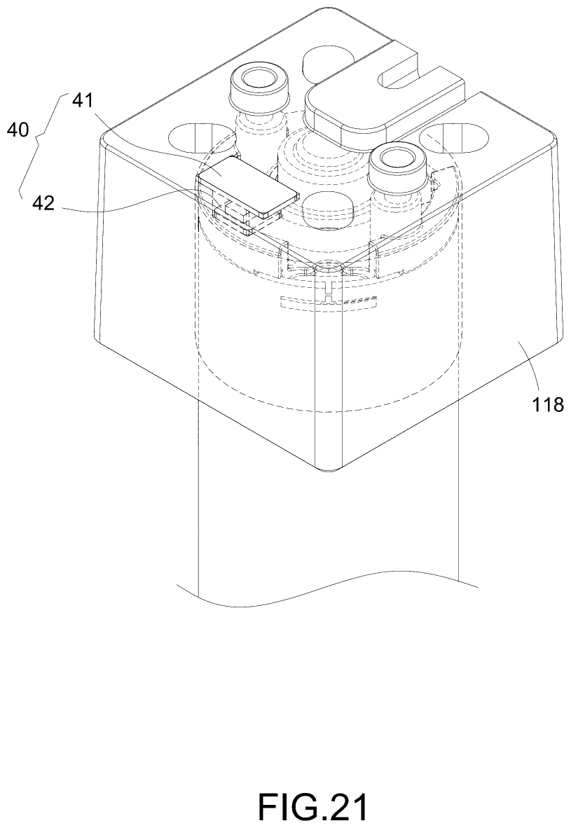

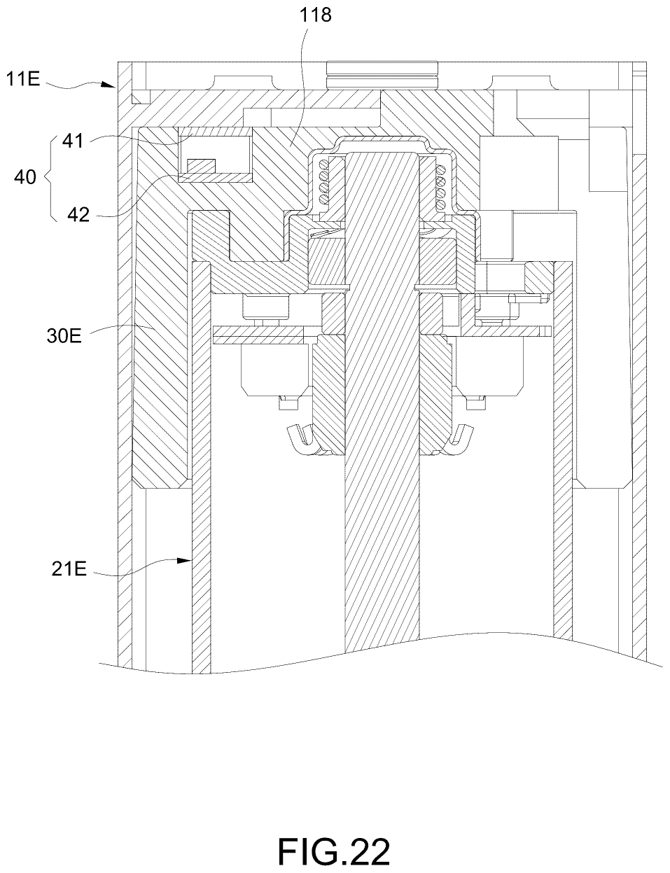

Please refer to FIG. 20 to FIG. 22, which are an exploded view, a schematic view showing the assembly of the partial components and a cross-sectional view showing the assembly according to the ninth embodiment of the present disclosure. According to this embodiment, the linear actuator is a lifting column. The fasten component 11E is an outer pipe of the lifting column. The fasten component 11E includes a cover cap 118. The first sensing member 41 is disposed on the cover cap 118, and the first sensing member 41 is a magnetic member.

The transmission mechanism 20 is connected to the housing body 10. According to this embodiment, the transmission mechanism 20 mainly includes a forced component 21E. The forced component 21E is a columnar electric push rod. In this embodiment, an elastic body 30E is a rubber pad. The fasten component 11E covers one end of the columnar electric push rod via the cover cap 118. The elastic body 30E is clamped between the cover cap 118 and the forced component 21E. The second sensing member 42 is disposed on the elastic body 30E and arranged corresponding to the first sensing member 41. The second sensing member 42 is a Hall sensor.

When being operated, a machine core of the columnar electric push rod is applied with an axial force, and the elastic body 30E generates deformations, a gap defined between the columnar electric push rod and the cover cap 118 is changed, and thus a signal is generated between the first sensing member 41 and the second sensing member 42 to be outputted.

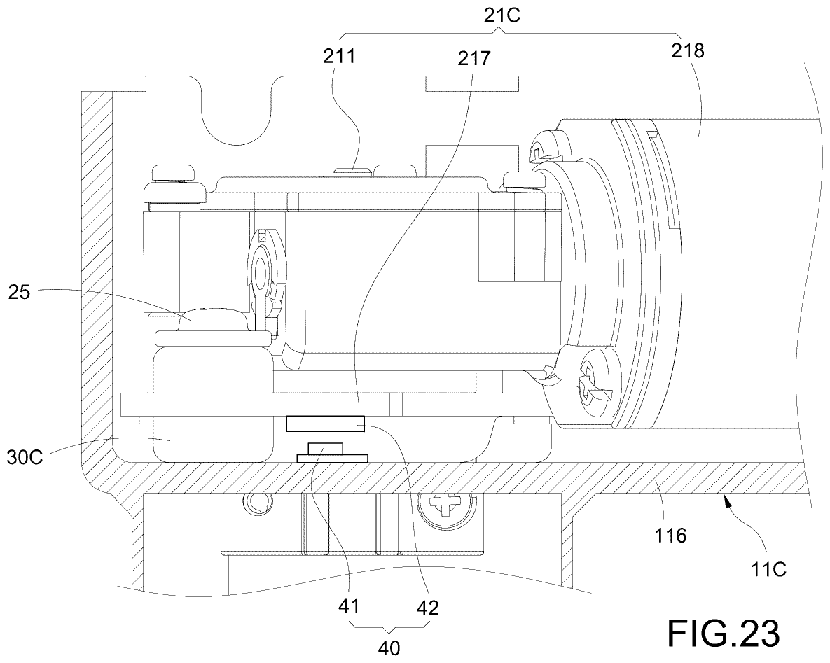

Please refer to FIG. 23, which is a cross-sectional view showing the assembly according to the tenth embodiment of the present disclosure. According to this embodiment, the linear actuator is a lifting column. The structure of the linear actuator disclosed in this embodiment is substantially the same as the structure disclosed in the seventh embodiment. The differences between this embodiment and the seventh embodiment are provided as follows. The first sensing member 41 is disposed on the bottom plate 116, and the first sensing member 41 is a Hall sensor. The second sensing member 42 is disposed at a bottom end of the fasten plate 217, and the second sensing member 42 is a magnetic member.

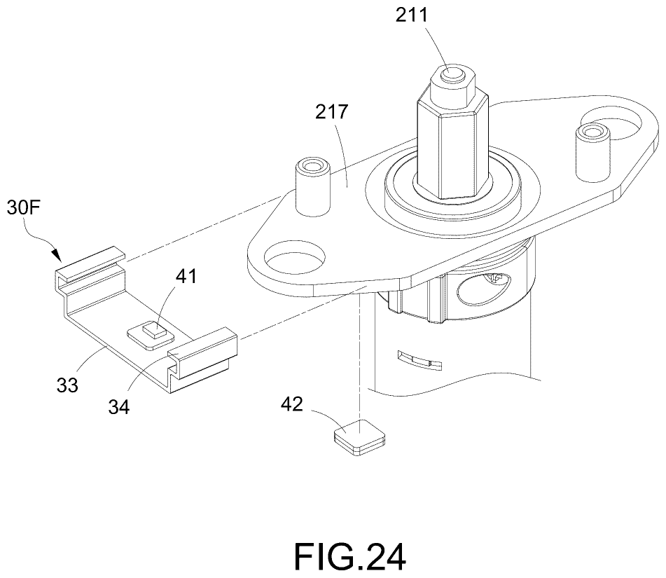

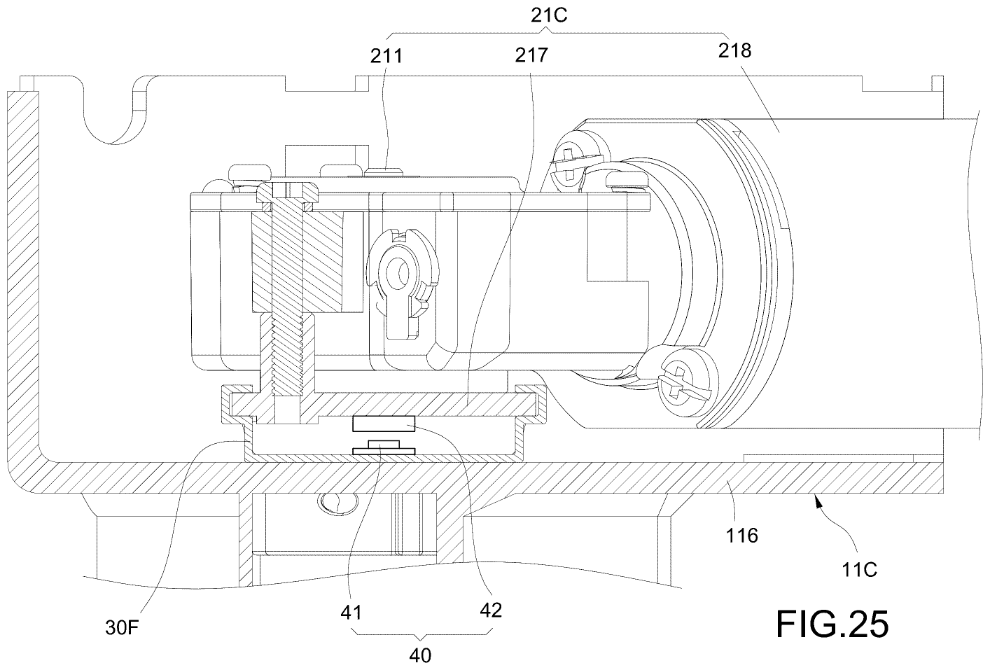

Please refer to FIG. 24 and FIG. 25, which are an exploded view and a cross-sectional view showing the assembly according to the eleventh embodiment of the present disclosure. According to this embodiment, the linear actuator is a lifting column. The structure of the linear actuator disclosed in this embodiment is substantially the same as the structure disclosed in the tenth embodiment. The differences between this embodiment and the tenth embodiment are provided as follows. The elastic body 30F is configured in a U-like shape. The elastic body 30F has a sealed end 33 and an opened end 34. The opened end 34 is connected to the fasten plate 217. The sealed end 33 is disposed on the bottom plate 116. The first sensing member 41 is disposed at the sealed end 33 of the elastic body 30F, and the first sensing member 41 is a Hall sensor. The second sensing member 42 is disposed at a bottom end of the fasten plate 217, and the second sensing member 42 is a magnetic member.

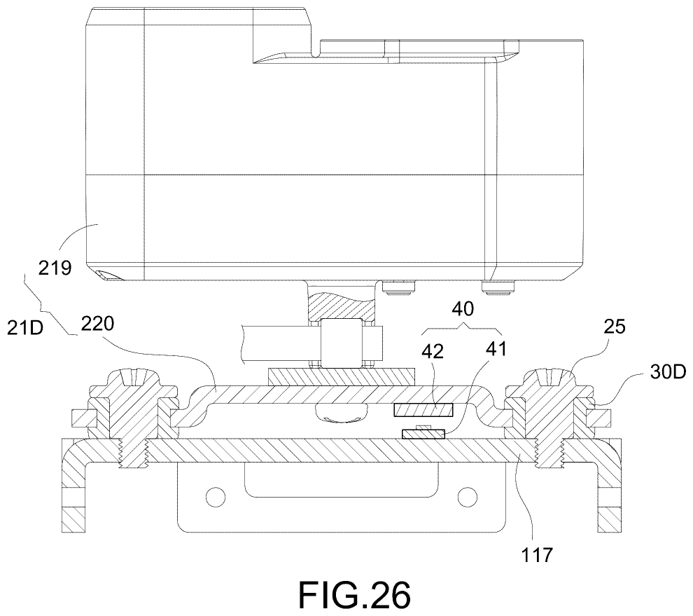

Please refer to FIG. 26, which is a cross-sectional view showing the assembly according to the twelfth embodiment of the present disclosure. According to this embodiment, the linear actuator is a lifting column. The structure of the linear actuator disclosed in this embodiment is substantially the same as the structure disclosed in the eighth embodiment. The differences between this embodiment and the eighth embodiment are provided as follows. The first sensing member 41 is disposed on the bottom cover 117, and the first sensing member 41 is a Hall sensor. The second sensing member 42 is disposed at a bottom end of the installing plate 220, and the second sensing member 42 is a magnetic member.

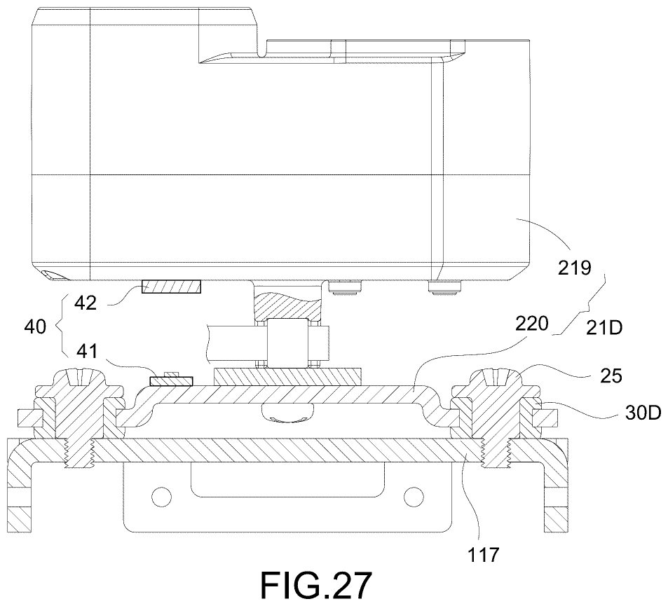

Please refer to FIG. 27, which is a cross-sectional view showing the assembly according to the thirteenth embodiment of the present disclosure. According to this embodiment, the linear actuator is a lifting column. The structure of the linear actuator disclosed in this embodiment is substantially the same as the structure disclosed in the twelfth embodiment. The differences between this embodiment and the twelfth embodiment are provided as follows. The first sensing member 41 is disposed on the installing plate 220, and the first sensing member 41 is a Hall sensor. The second sensing member 42 is disposed at a bottom end of the electric push rod 219, and the second sensing member 42 is a magnetic member.

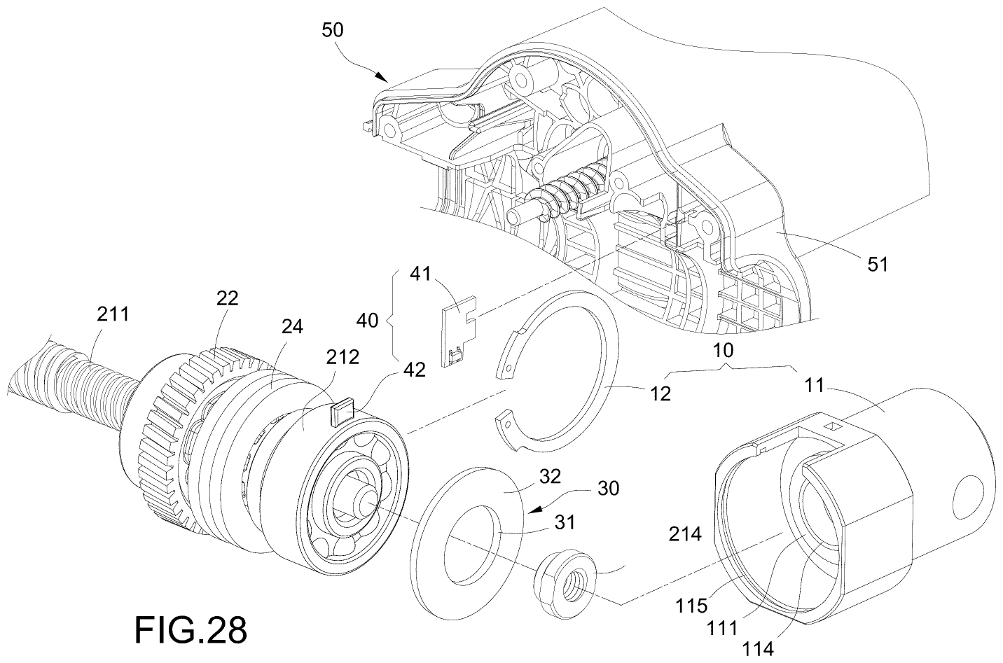

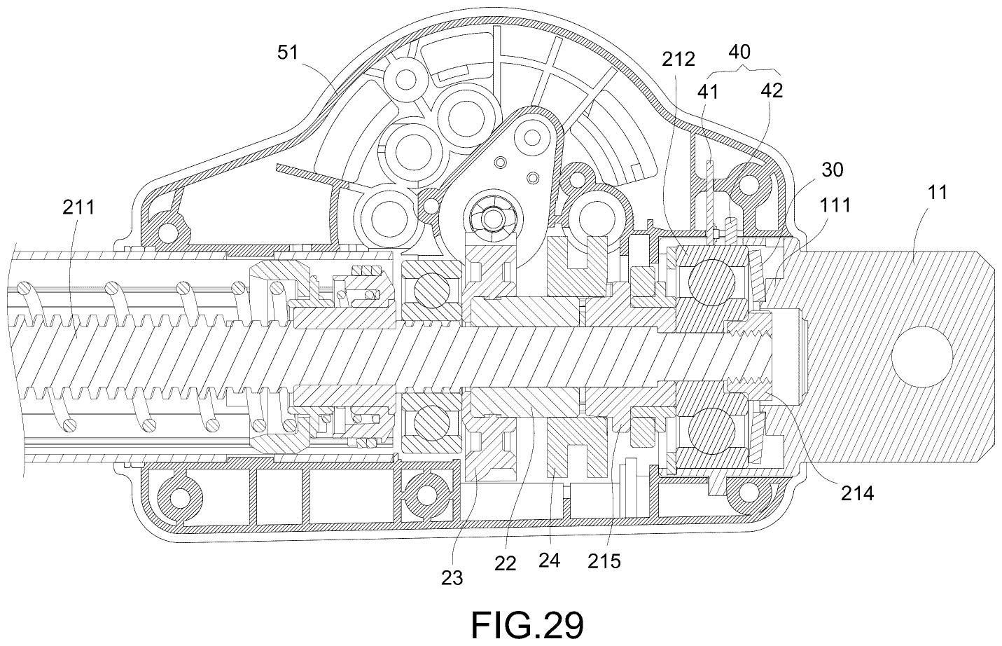

Please refer to FIG. 28 and FIG. 29, which are an exploded view and a cross-sectional view showing the assembly according to the fourteenth embodiment of the present disclosure. According to this embodiment, the linear actuator is an electric push rod. The structure of the linear actuator disclosed in this embodiment is substantially the same as the structure disclosed in the first embodiment. The differences between this embodiment and the first embodiment are provided as follows. The first sensing member 41 is disposed in the motor case 51 of the drive mechanism 50, and the first sensing member 41 is a Hall sensor. The second sensing member 42 is disposed at a top end of the bearing 212, and the second sensing member 42 is a magnetic member.

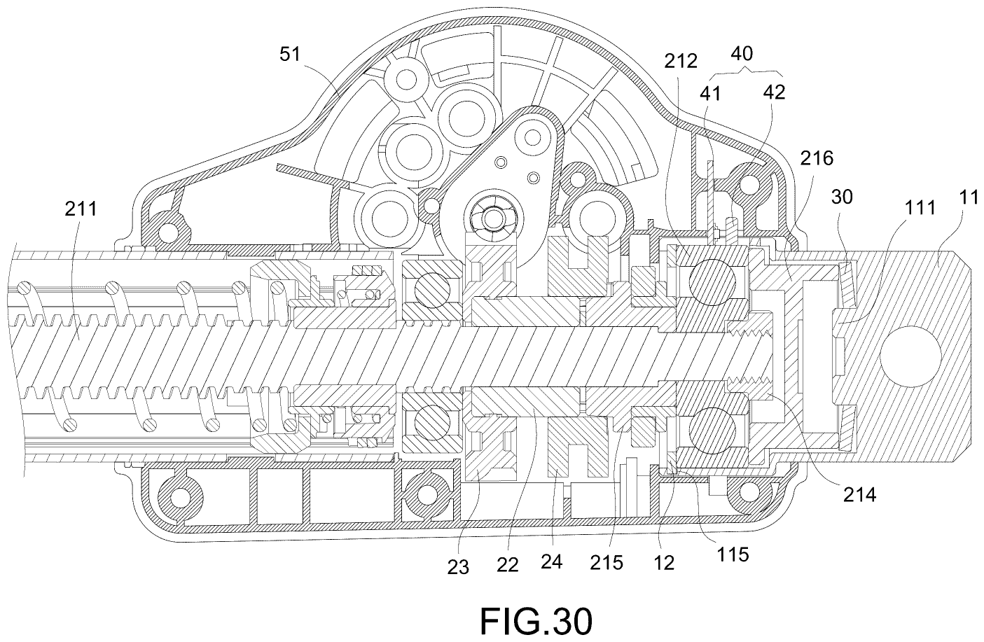

Please refer to FIG. 30, which is a cross-sectional view showing the assembly according to the fifteenth embodiment of the present disclosure. According to this embodiment, the linear actuator is an electric push rod. The structure of the linear actuator disclosed in this embodiment is substantially the same as the structure disclosed in the fifth embodiment. The differences between this embodiment and the fifth embodiment are provided as follows. The first sensing member 41 is disposed in the motor case 51 of the drive mechanism 50, and the first sensing member 41 is a Hall sensor. The second sensing member 42 is disposed at a top end of the bearing 212, and the second sensing member 42 is a magnetic member.

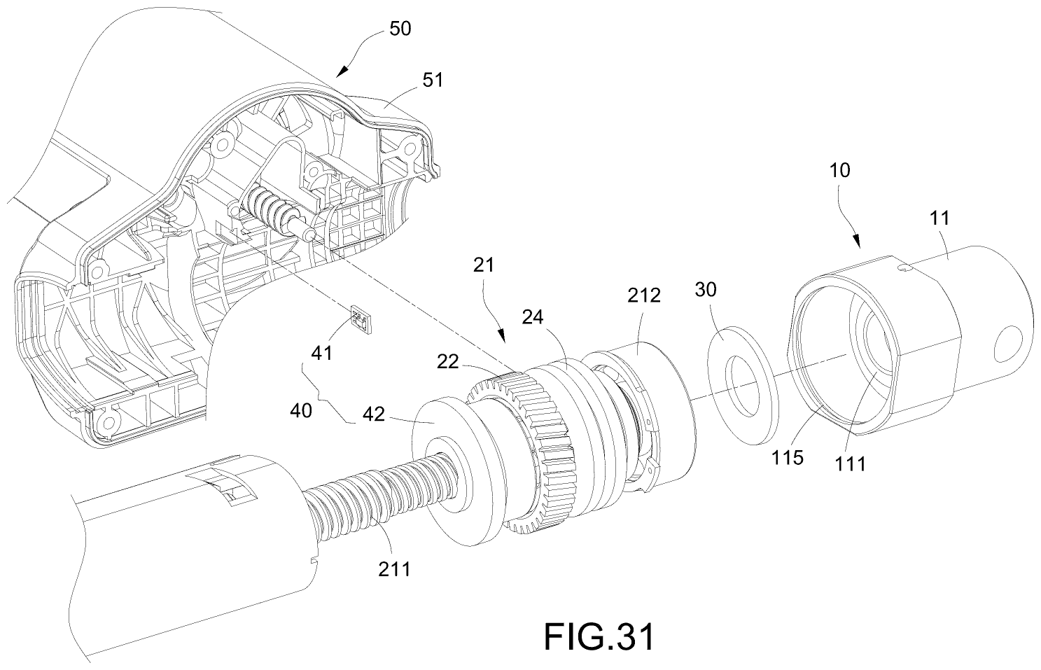

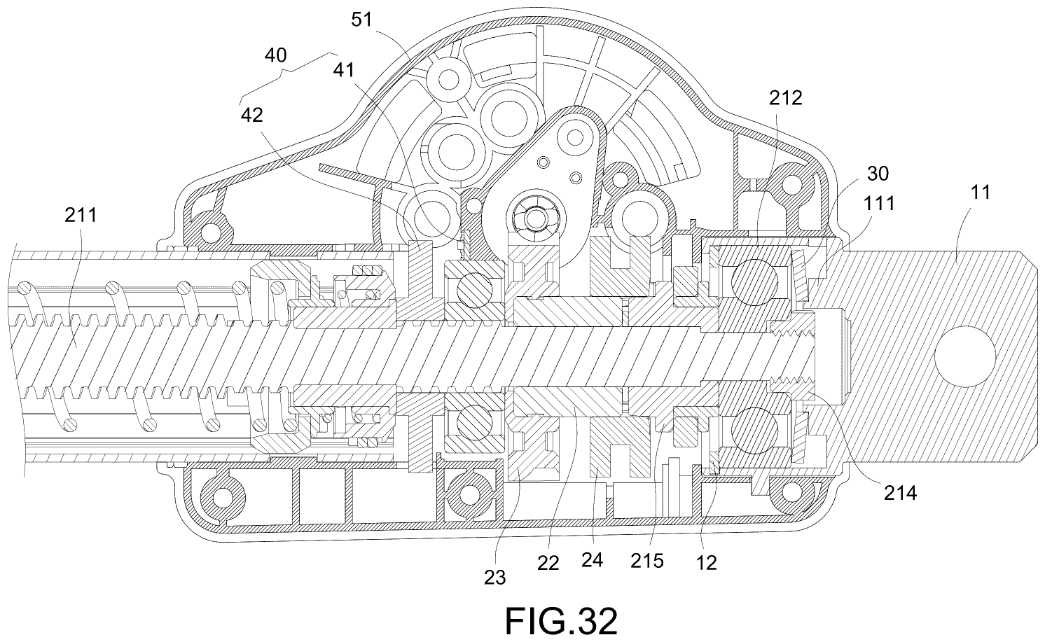

Please refer to FIG. 31 and FIG. 32, which are an exploded view and a cross-sectional view showing the assembly according to the sixteenth embodiment of the present disclosure. According to this embodiment, the linear actuator is an electric push rod. The structure of the linear actuator disclosed in this embodiment is substantially the same as the structure disclosed in the fourteenth embodiment. The differences between this embodiment and the fourteenth embodiment are provided as follows. The first sensing member 41 is disposed in the motor case 51 of the drive mechanism 50, and the first sensing member 41 is a Hall sensor. The second sensing member 42 is disposed on the machine core 211, and the second sensing member 42 is a magnetic member.

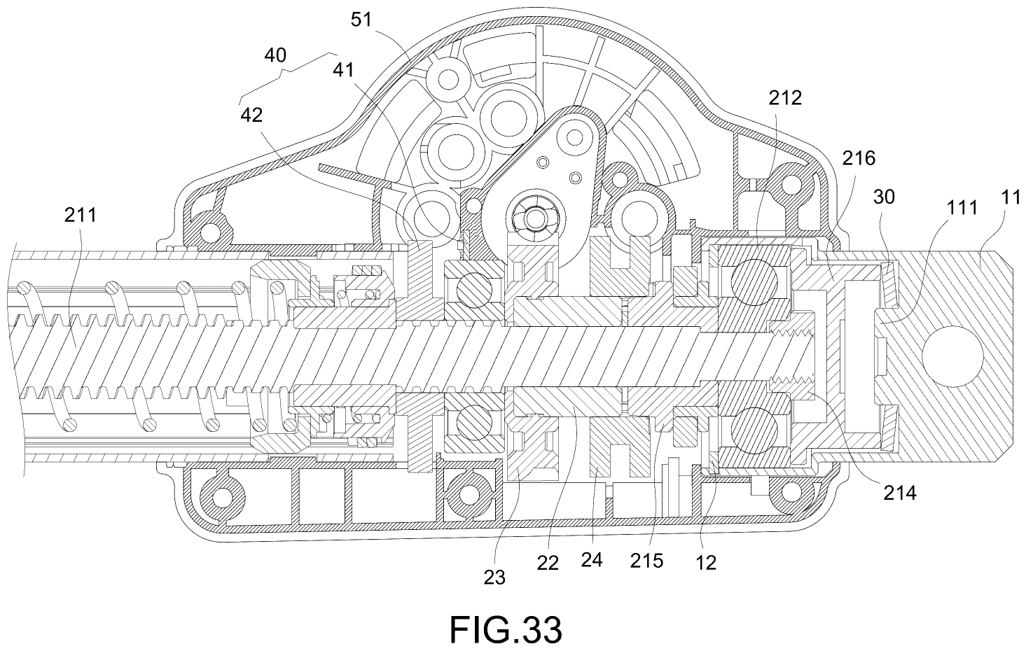

Please refer to FIG. 33, which is a cross-sectional view showing the assembly according to the seventeenth embodiment of the present disclosure. According to this embodiment, the linear actuator is an electric push rod. The structure of the linear actuator disclosed in this embodiment is substantially the same as the structure disclosed in the fifteenth embodiment. The differences between this embodiment and the fifteenth embodiment are provided as follows. The first sensing member 41 is disposed in the motor case 51 of the drive mechanism 50, and the first sensing member 41 is a Hall sensor. The second sensing member 42 is disposed on the machine core 211, and the second sensing member 42 is a magnetic member.

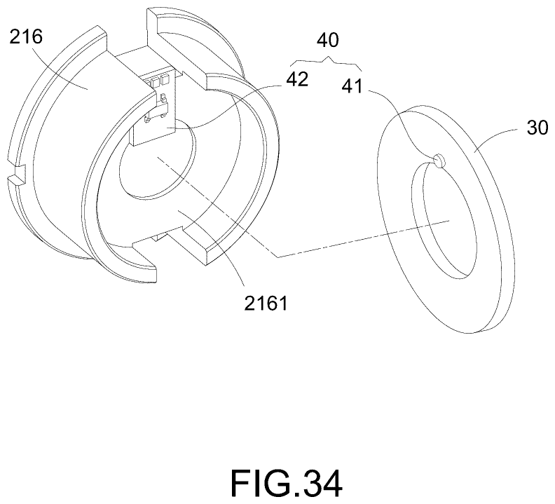

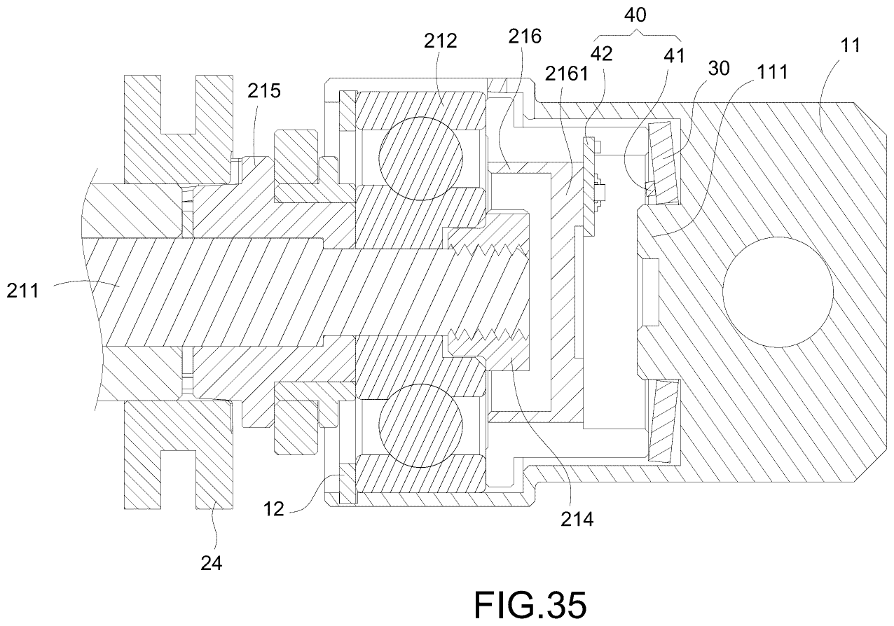

Please refer to FIG. 34 and FIG. 35, which are an exploded view and a cross-sectional view showing the assembly according to the eighteenth embodiment of the present disclosure. According to this embodiment, the linear actuator is an electric push rod. The structure of the linear actuator disclosed in this embodiment is substantially the same as the structure disclosed in the fifteenth embodiment. The differences between this embodiment and the fifteenth embodiment are provided as follows. The first sensing member 41 is disposed on the elastic body 30, and the first sensing member 41 is a magnetic member. The second sensing member 42 is disposed on the middle partition plate 2161 of the sleeve 216, and the second sensing member 42 is a Hall sensor.

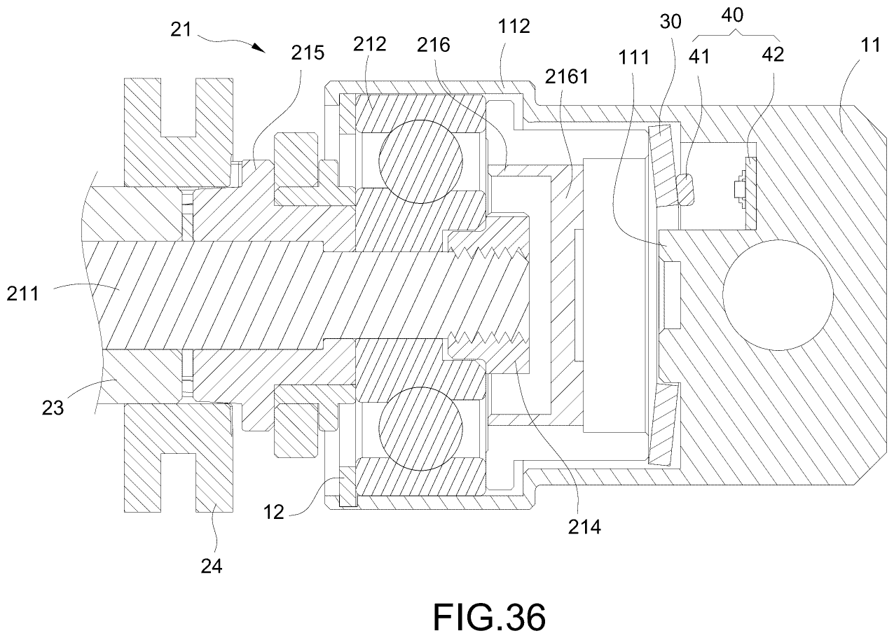

Please refer to FIG. 36, which is a cross-sectional view showing the assembly according to the nineteenth embodiment of the present disclosure. According to this embodiment, the linear actuator is an electric push rod. The structure of the linear actuator disclosed in this embodiment is substantially the same as the structure disclosed in the eighteenth embodiment. The differences between this embodiment and the eighteenth embodiment are provided as follows. The first sensing member 41 is disposed on the elastic body 30, and the first sensing member 41 is a magnetic member. The second sensing member 42 is disposed in the fasten component 11, and the second sensing member 42 is a Hall sensor.

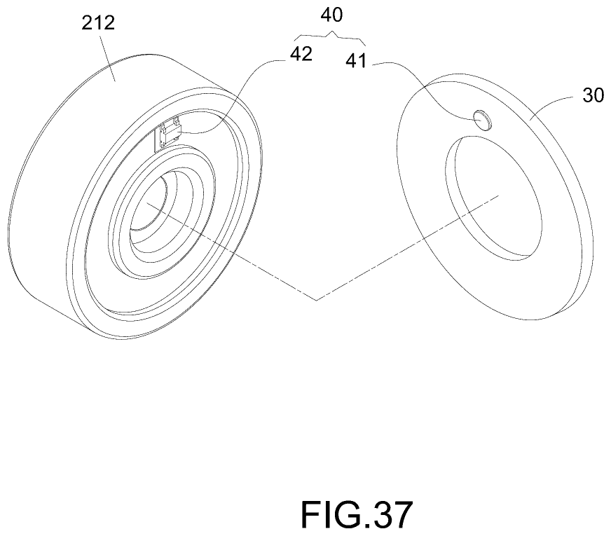

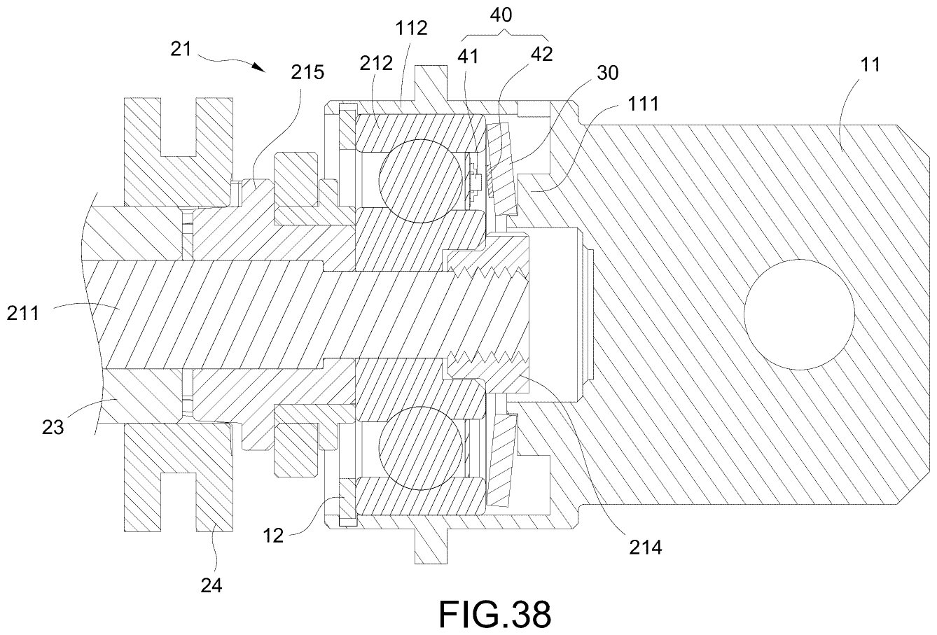

Please refer to FIG. 37 and FIG. 38, which are an exploded view and a cross-sectional view showing the assembly according to the twentieth embodiment of the present disclosure. According to this embodiment, the linear actuator is an electric push rod. The structure of the linear actuator disclosed in this embodiment is substantially the same as the structure disclosed in the sixteenth embodiment. The differences between this embodiment and the sixteenth embodiment are provided as follows. The first sensing member 41 is disposed on the elastic body 30, and the first sensing member 41 is a magnetic member. The second sensing member 42 is disposed on the bearing 212, and the second sensing member 42 is a Hall sensor.

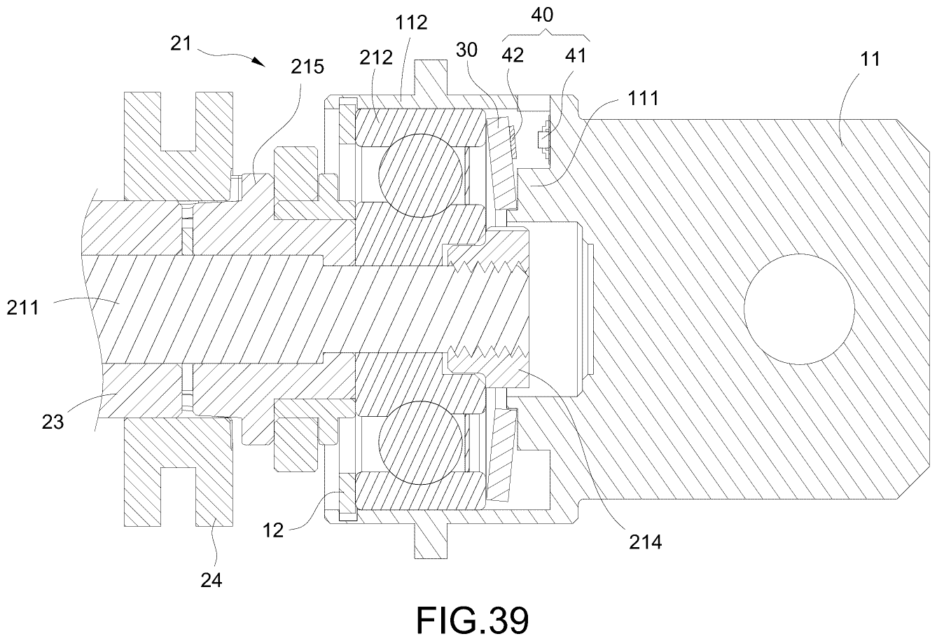

Please refer to FIG. 39, which is a cross-sectional view showing the assembly according to the twenty-first embodiment of the present disclosure. According to this embodiment, the linear actuator is an electric push rod. The structure of the linear actuator disclosed in this embodiment is substantially the same as the structure disclosed in the twentieth embodiment. The differences between this embodiment and the twentieth embodiment are provided as follows. The first sensing member 41 is disposed in fasten component 11, and the first sensing member 41 is a Hall sensor. The second sensing member 42 is disposed on the elastic body 30, and the second sensing member 42 is a magnetic member.

While this disclosure has been described by means of specific embodiments, numerous modifications and variations may be made thereto by those skilled in the art without departing from the scope and spirit of this disclosure set forth in the claims.

What is claimed is:

1. A linear actuator with a force detecting mechanism, comprising:
a housing body (10), comprising a fasten component (11);
a transmission mechanism (20), connected to the housing body (10) and comprising a forced component (21);
an elastic body (30), disposed between the fasten component (11) and the forced component (21); and
a Hall sensing set (40), disposed between the fasten component (11) and the forced component (21);
wherein, when a force applied to the transmission mechanism (20) is changed, a relative displacement is generated between the forced component (21) and the fasten component (11), and thus an output signal is generated by the Hall sensing set (40) due to the displacement.

2. The linear actuator with the force detecting mechanism according to claim 1, wherein the Hall sensing set (40) comprises a first sensing member (41) and a second sensing member (42) disposed relative to the first sensing member (41), the first sensing member (41) is disposed in the fasten component (11), and the second sensing member (42) is disposed in the forced component (21).

3. The linear actuator with the force detecting mechanism according to claim 2, wherein the fasten component (11) comprises a convex piece (111), the convex piece (111) comprises a cavity (113), the forced component (21) comprises a machine core (211), the first sensing member (41) is a magnetic member and disposed in the cavity (113), and the second sensing member (42) is a Hall sensor and disposed on an end surface of the machine core (211).

4. The linear actuator with the force detecting mechanism according to claim 2, wherein the fasten component (11) comprises an inner annular ring (114), the forced component (21) comprises a bearing (212), the elastic body (30) is an inclined disc-shaped elastic sheet, the elastic body (30) comprises a central hole (31) and an inclined plate (32) disposed at an outer circumference of the central hole (31), the central hole (31) sheaths the inner annular ring

(114) and the inclined plate (32) abuts against the bearing (212) in a zone away from the central hole (31).

5. The linear actuator with the force detecting mechanism according to claim 2, wherein the fasten component (11) comprises a convex piece (111), the convex piece (111) comprises a cavity (113), the forced component (21) comprises a machine core (211), the first sensing member (41) is a Hall sensor and disposed in the cavity (113), and the second sensing member (42) is a magnetic member and disposed on an end surface of the machine core (211).

6. The linear actuator with the force detecting mechanism according to claim 2, wherein the fasten component (11) comprises a convex piece (111), the convex piece (111) comprises a cavity (113), the forced component (21A) comprises a machine core (211), a bearing (212) and a sleeve (216), the machine core (211) passes through the bearing (212), the sleeve (216) is disposed between the bearing (212) and the elastic body (30), the first sensing member (41) is a magnetic member and disposed in the cavity (113), and the second sensing member (42) is a Hall sensor and disposed on an end surface of the machine core (211).

7. The linear actuator with the force detecting mechanism according to claim 2, wherein the fasten component (11) comprises a convex piece (111), the forced component (21A) comprises a machine core (211), a bearing (212) and a sleeve (216), the machine core (211) passes through the bearing (212), the sleeve (216) is disposed between the bearing (212) and the elastic body (30), the first sensing member (41) is a Hall sensor and disposed on the convex piece (111), and the second sensing member (42) is a magnetic member and disposed on an end surface of the machine core (211).

8. The linear actuator with the force detecting mechanism according to claim 2, wherein the fasten component (11) comprises a convex piece (111), the convex piece (111) comprises a cavity (113), the forced component (21B) comprises a machine core (211), a bearing (212) and a sleeve (216), the machine core (211) passes through the bearing (212), the sleeve (216) is disposed between the bearing (212) and the elastic body (30), the sleeve (216) comprises a middle partition plate (2161), the first sensing member (41) is a magnetic member and disposed in the cavity (113), and the second sensing member (42) is a Hall sensor and disposed on the middle partition plate (2161).

9. The linear actuator with the force detecting mechanism according to claim 2, wherein the fasten component (11) comprises a convex piece (111), the forced component (21B) comprises a bearing (212) and a sleeve (216), the sleeve (216) is disposed between the bearing (212) and the elastic body (30), the sleeve (216) comprises a middle partition plate (2161), the first sensing member (41) is a Hall sensor and disposed on the convex piece (111), and the second sensing member (42) is a magnetic member and disposed on the middle partition plate (2161).

10. The linear actuator with the force detecting mechanism according to claim 2, wherein the fasten component (11C) comprises a bottom plate (116), the forced component (21C) comprises a motor (218), the first sensing member (41) is a Hall sensor and disposed on the bottom plate (116), and the second sensing member (42) is a magnetic member and disposed on the motor (218).

11. The linear actuator with the force detecting mechanism according to claim 2, wherein the fasten component (11D) comprises a bottom cover (117), the forced component (21D) comprises an installing plate (220), the first sensing member (41) is a magnetic member and disposed on the bottom cover (117), and the second sensing member (42) is a Hall sensor and disposed on the installing plate (220).

12. The linear actuator with the force detecting mechanism according to claim 2, wherein the fasten component (11C) comprises a bottom plate (116), the forced component (21C) comprises a fasten plate (217), the first sensing member (41) is a Hall sensor and disposed on the bottom plate (116), and the second sensing member (42) is a magnetic member and disposed on the fasten plate (217).

13. The linear actuator with the force detecting mechanism according to claim 2, wherein the fasten component (11D) comprises a bottom cover (117), the forced component (21D) comprises an installing plate (220), the first sensing member (41) is a Hall sensor and disposed on the bottom cover (117) and the second sensing member (42) is a magnetic member and disposed at a bottom end of the installing plate (220).

14. The linear actuator with the force detecting mechanism according to claim 1, wherein the fasten component (11E) comprises a cap cover (118), the Hall sensing set (40) comprises a first sensing member (41) and a second sensing member (42) arranged corresponding to the first sensing member (41), the first sensing member (41) is a magnetic member and disposed on the cap cover (118), and the second sensing member (42) is a Hall sensor and disposed on the elastic body (30E).

15. The linear actuator with the force detecting mechanism according to claim 1, wherein the fasten component (11C) comprises a bottom plate (116), the forced component (21C) comprises a fasten plate (217), the elastic body (30F) comprises a sealed end (33) and an opened end (34), the opened end (34) is connected to the fasten plate (217), the sealed end (33) is disposed on the bottom plate (116), the Hall sensing set (40) comprises a first sensing member (41) and a second sensing member (42) arranged corresponding to the first sensing member (41), the first sensing member (41) is a Hall sensor and disposed at the sealed end (33), and the second sensing member (42) is a magnetic member and disposed at a bottom end of the fasten plate (217).

16. The linear actuator with the force detecting mechanism according to claim 1, wherein the forced component (21D) comprises an installing plate (220) and an electric push rod (219), the Hall sensing set (40) comprises a first sensing member (41) and a second sensing member (42) arranged corresponding to the first sensing member (41), the first sensing member (41) is a Hall sensor and disposed on the installing plate (220), and the second sensing member (42) is a magnetic member and disposed at a bottom end of the electric push rod (219).

17. The linear actuator with the force detecting mechanism according to claim 1, wherein further comprising a drive mechanism (50), the drive mechanism (50) comprises a motor case (51), the Hall sensing set (40) comprises a first sensing member (41) and a second sensing member (42) arranged corresponding to the first sensing member (41), the first sensing member (41) is disposed in the motor case (51), and the second sensing member (42) is disposed in the forced component (21).

18. The linear actuator with the force detecting mechanism according to claim 17, wherein the forced component (21) comprises a bearing (212), the first sensing member (41) is a Hall sensor and disposed in the motor case (51), and the second sensing member (42) is a magnetic member and disposed on the bearing (212).

19. The linear actuator with the force detecting mechanism according to claim 17, wherein the forced component (21) comprises a bearing (212) and a sleeve (216), the sleeve (216) is disposed between the bearing (212) and the elastic body (30), the first sensing member (41) is a Hall sensor and disposed in the motor case (51), and the second sensing member (42) is a magnetic member and disposed on the bearing (212).

20. The linear actuator with the force detecting mechanism according to claim 17, wherein the forced component (21) comprises a machine core (211), the first sensing member (41) is a Hall sensor and disposed in the motor case (51), and the second sensing member (42) is a magnetic member and disposed on the machine core (211).

21. The linear actuator with the force detecting mechanism according to claim 20, wherein the forced component (21) further comprises a sleeve (216), and the sleeve (216) is disposed between the bearing (212) and the elastic body (30).

22. The linear actuator with the force detecting mechanism according to claim 1, wherein the Hall sensing set (40) comprises a first sensing member (41) and a second sensing member (42) arranged corresponding to the first sensing member (41), the first sensing member (41) is disposed on the elastic body (30), and the second sensing member (42) is disposed in the forced component (21).

23. The linear actuator with the force detecting mechanism according to claim 22, wherein the forced component (21) comprises a bearing (212) and a sleeve (216), the sleeve (216) is disposed between the bearing (212) and the elastic body (30), the sleeve (216) comprises a middle partition plate (2161), the first sensing member (41) is a magnetic member and disposed on the elastic body (30), and the second sensing member (42) is a Hall sensor and disposed on the middle partition plate (2161).

24. The linear actuator with the force detecting mechanism according to claim 22, wherein the forced component (21) comprises a bearing (212) and a sleeve (216), the sleeve (216) is disposed between the bearing (212) and the elastic body (30), the first sensing member (41) is a magnetic member and disposed on the elastic body (30), and the second sensing member (42) is a Hall sensor and disposed in the fasten component (11).

25. The linear actuator with the force detecting mechanism according to claim 22, wherein the forced component (21) comprises a bearing (212), the first sensing member (41) is a Hall sensor and disposed on the elastic body (30), and the second sensing member (42) is a magnetic member and disposed on the bearing (212).

26. The linear actuator with the force detecting mechanism according to claim 1, wherein the Hall sensing set (40) comprises a first sensing member (41) and a second sensing member (42) arranged corresponding to the first sensing member (41), the first sensing member (41) is a Hall sensor and disposed in the fasten component (11), and the second sensing member (42) is a magnetic member and disposed on the elastic body (30).
